(19) United States
(12) Patent Application Publication
(10) Pub. No.: US 2021/0192538 A1
(43) Pub. Date: Jun. 24, 2021

(54) AGENT FOR PROTECTING THE PRIVACY OF END-USERS OF BUSINESS TRANSACTIONS

(71) Applicants: Vatche VARVARIAN, Montreal (CA); Gilbert ABIRACHED, Montreal (CA)

(72) Inventors: Vatche VARVARIAN, Montreal (CA); Gilbert ABIRACHED, Montreal (CA)

(21) Appl. No.: 17/127,567

(22) Filed: Dec. 18, 2020

Related U.S. Application Data
(60) Provisional application No. 62/951,739, filed on Dec. 20, 2019.

(51) Int. Cl. G06Q 30/00; G06Q 10/10; G06Q 30/06; G06Q 20/38; G06Q 30/02; G06Q 20/40; G06F 16/27; G06F 21/62

(52) U.S. Cl. CPC G06Q 30/018; G06Q 10/10; G06Q 30/0611; G06Q 20/389; G06Q 30/0609; G06Q 30/0222; G06Q 50/265; G06Q 20/4015; G06Q 30/0276; G06Q 30/0269; G06Q 30/0246; G06F 16/27; G06F 21/6254; G06Q 30/0226

(57) ABSTRACT

An agent provides anonymity to users of business transactions. The agent acts as an interface between the users and businesses accessible. The businesses are identified as trusted, semi-trusted or non-trusted by the agent. The agent enforces terms and conditions of smart contracts agreed upon by the businesses and intended to protect the privacy of the users. A user may purchase goods and/or services from a business without revealing their identity to the business. Advertisements from this or other businesses may or may not reach the user depending on the user's preferences. The agent may collect loyalty points from the businesses on behalf of the users while maintaining the confidentiality of the users. The businesses may collect only data about the agent and a platform that implements the agent without collecting data about the users.

### CROSS-REFERENCE TO RELATED APPLICATIONS

This application claims the benefit of U.S. Provisional Patent Application No. 62/951,739 filed Dec. 20, 2019, which is incorporated by reference herein in its entirety.

### FIELD OF TECHNOLOGY

The present disclosure relates generally to a digital agent/intermediary. The digital agent may perform transactions online (ecommerce) and/or in a physical store while shielding the user's data and/or identity, thereby protecting the user's data privacy based on user consent and interest.

### BACKGROUND

When users perform digital transactions and/or engage in omnichannel retail such as when searching for information, using an application, using social media, making a purchase online or in-store, using loyalty points, receiving goods (i.e. delivery) or services (i.e. restaurant reservation), the users need to provide their data individually to various businesses who will store it/manage the data however the businesses want. In addition, users sign individually the different terms and conditions from each of these businesses. This results in user data getting stolen, sold or used without the users' consent and without the users' knowledge.

The data that the user sees as a result from search engines or on social media is sometimes not real, because the search engines provides the websites who paid most. On social media, users may be shown information that is advertised by people paying the social media operator. The source of the information/advertising is not always validated, and this could result in fraud.

Businesses track users' data trails, gathered from multiple sources (GPS, social media likes, web pages accessed, eavesdropping . . . ) perform cross-references using AI/Analytics, guess/profile users to advertise and to influence/manipulate users' decisions without the users' consent or knowledge. Users are receiving many advertisements/information that don't necessarily meet their needs or that are influencing the users. Basically, a user's data may be used against them so that the user is influenced by a business. These businesses may be profiting by selling the user's data, such as to advertising companies and others. The user might not receive any compensation for the sale of their user data, even though the user is the origin of the data.

When a user performs a search, using a search engine, such as Google search, the data of the user's search might not be kept confidential. This data could be used as business intelligence information about the user or a business, it could be used to push unwanted advertising to the user (based on their search), and/or used for other purposes. This initial data of the user, in addition to treated data (after analytics/AI operations performed on the data) is stored at the business, or any of their data partners (such as data aggregators).

If a user uses a website, the website owner may store a cookie on the user's computer without the user's knowledge and consent so that the web site owner or another party can begin collecting information on the user such as location data, IP address, habits, etc. This data is collected to enrich the data lake that these businesses are collecting. Some businesses own more than one medium: search engine, social media or they have agreements with the other businesses to share users' data amongst themselves to enrich more the user data and to profile them in order to more accurately predict users' interests.

This user data may be sold and used without the user consent and knowledge. Users are not aware who is accessing their data and when, why and how they are using it. In some cases, consent is obtained without user understanding, because the user accepts the business terms and conditions that are drafted by the business lawyer in the interest of the business. Most of the time users don't take the time or are not provided the time to read these terms.

In some instances, the data aggregators and businesses that collect user data do not properly protect their collections of user data, and the user data may be accessed improperly and/or stolen without the users being notified.

The source of data that is gathered on users for advertising or other purposes is large and is tied to almost any digital transaction the user does or in-store as businesses are implementing omnichannel solutions. Examples of main sources of data collections on users are payment solutions (bank cards, credit cards, loyalty point cards, social media, websites, search engines, ecommerce sites, etc.). This makes it very difficult for users to protect their data privacy.

Users receives fake advertising because the source of advertising is not validated. Often whoever pays for advertising on social media can promote whatever they want without validation of their identity, nor truth of their products or advertising. As for search engines, whoever pays more gets their offering viewed first by the user even if it does not answer the user's needs. This could result in users purchasing fake products, getting fake information, etc.

Users sometimes receive unwanted advertising in instances where the user does not need to receive any advertising or information at all, or the advertising that the user receives is not what the user is interested in. In addition, sometimes the advertising is received not when it is needed where it is needed and from the source that is wanted. Further, there are instances where advertising may manipulate users because the data is obtained without the users' consent, cross-referenced from multiple channels analyzed by AI, analytics, customized and sent to users on multiple different mediums (Facebook, browser, etc.).

User data is also exposed when they list their products/services for sale on social media, ecommerce websites and other mediums. In some cases, you must register by your full name, you must specify your address, etc. Similarly user data may be exposed when users declare their intention to purchase products/services. This personal information can be used without the user's knowledge by advertising companies, by criminals, etc.

When users make purchases online or in the store using their credit cards and debit cards, their personal data that consists of their names, address, phone numbers, products/services purchased, is stored and used by many businesses from the supply chain: Issuing bank, retail business, and/or visa/credit card network. In some instances these businesses storing user data have been hacked and their customers' personal information was stolen and used for illegal activities. In addition, some of these businesses are using or selling users' personal data for marketing and other activities without user consent, knowledge or revenue sharing possibility.

When a client uses their loyalty card during a purchase, such as to collect points or other rewards, the client's digital identity and personal data will be exposed by using the loyalty card, even if the client's digital identity and personal data are protected with a digital wallet. The loyalty card system is another distributed system that is used to collect data on users in exchange for rewards from the businesses.

Shipping and receiving goods are another source of personal data leakage for users. Even if they use solutions to protect their data privacy during the payment process and loyalty points process, they will be exposed when shipping or receiving a product. This could cause a security issue (address of the originator or receiver of the good) and personal data may be used without consent.

The same risks apply when acquiring and receiving services, such as reservations, booking, and/or any other service. In this case, a user is unable to maintain their privacy when making the reservation.

### SUMMARY

Embodiments of the present technology have been developed based on developers' appreciation of at least one technical problem associated with the prior art solutions. Therefore, developers have devised methods and systems for protecting the privacy of users' and their data when performing transactions.

In a broad aspect of the present technology, there is provided a solution protecting the privacy of users' and their data, when performing major business transactions, comprising: a. A mechanism for users to define their terms and conditions (data privacy, how they can be contacted, by who, can their data be used or not, etc.) and interests that will be translated into smart contracts b. A legal contract made on behalf of the users to complement the smart contracts signed by all the members of the marketplace to comply with users' terms and conditions (data privacy: who can access my data, when, what they can do with my data). c. An agent/broker (data privacy gateway) that will act as an intermediary between the user ands the business partners to perform the transactions (search and ask, advertise and market, buy and sell, pay and go, manage loyalty points, ship and receive, view data and trade data, etc.) in the marketplace or outside the marketplace d. A unique ID that identifies the user per transaction or a series of transactions to allow him to perform that transaction without providing his personal data and without allowing businesses to track him or guess who he is based on history of other transactions e. A mechanism to identify and inform the user about the type of businesses (trusted, non trusted, semi-trusted) he is about to deal with f. A search & ask mechanism that protect the user's identity, privacy, and from unsolicited and unwanted advertising and marketing, when performing the transaction in the marketplace and outside the marketplace g. An advertising mechanism that communicates to the users based on their interests and conditions in the marketplace and outside the marketplace h. A buy and sell mechanism that protects users' identity and data when performing the transaction in the marketplace or outside i. A pay and go mechanism that protects users' identity and data when performing the transaction in the marketplace or outside j. A ship and receive mechanism that protects users' identity and data when receiving products or services inside or outside the marketplace. k. A temporary email address that protects users' identity and data when providing their email address or when communicating by email 1. A manage loyalty points mechanism that protects user's identity and data when receiving loyalty points inside or outside the marketplace. m. A trading data mechanism that protects user's identity and data when providing analytics/business intelligence about the platform n. A secure data storage system that protects user's data and privacy o. An analytic system compliant with users' terms and conditions p. A distributed ledger technology (DLT) to record the transactions and provide data transactions transparency q. Other security mechanism: encryption, IAM, etc. r. A business model (offering intention' based customers with consent) that does not encourage businesses to invest efforts and money to try to identify and/or spy on users.

In another broad aspect of the present technology, there is a platform that offers a central and a unique way to use personal data when performing transactions in a private community (marketplace) or outside the community in the store, comprising: a. A single data privacy contract/terms and conditions (legal and digital/smart contracts) for all businesses and transactions b. A unique and central data storage that protects data and users' privacy c. Agent/Broker/Privacy gateway that offers a unique way to interact with different business interfaces to perform transactions on behalf of the users d. Agent/Broker/Privacy gateway protects the user's data and privacy in the online private community (marketplace) or outside the marketplace (in-store), using the existing model (payment, loyalty points, shipping)

In another broad aspect of the present technology, there is an online trusted marketplace (private community) for anonymous business transactions (such as buy, sell transactions), comprising: a. Transactions (buy and sell) performed between trusted (signed legal terms and conditions and comply with user interests and data privacy) community members b. An agent/broker/privacy gateway that performs the business transaction (buy and sell) on behalf of the buyer and seller complying with their terms and conditions (data privacy, price, interests) and shielding their identity. c. Users and Businesses can keep their identity anonymous using dynamic IDs such as a Unique identity assigned to each member, for each transaction, to keep them anonymous, hence protecting their data privacy d. A smart contract platform that complies with the user's data privacy conditions, price, transaction conditions, payment method, information access, etc. e. A distributed ledger technology to record the transactions in an uncontested way and provide transparency f. All transactions are controlled end to end by the agent/platform

In another broad aspect of the present technology, there is an agent/broker/privacy gateway acting on behalf of the user, protecting his data privacy, when doing business transactions in a private community or outside the community (online or instore, comprising: a. Multiple interfaces (application, card) to deal with different type of transactions online or instore. b. Different shapes; Hardware with voice recognition, SW or API, UI/UX, QR code, to interface with the user and other business partners c. Performs transactions on behalf of the user: i. Search and ask: Ask a question, search for content, products or services. ii. Advertise and market products or services iii. Buy and sell products or services iv. Pay and go v. Manage (collect/use) loyalty points vi. Ship and receive goods or services (Shipment, booking (restaurant/hotel)) vii. Trade data (analytics and business intelligence information) d. A mechanism to perform transactions on behalf of the users/businesses by not exposing user data or identity, keeping their identity and data anonymous e. Protect the user identity and ensure that businesses comply with his consent (intention, data privacy) by searching, making the payment and receiving the products/services on his behalf and collecting/redeeming points using a one-time identity per transaction f Validate each transaction with the user prior to completing, using smart contracts and DLT for transparency and to comply with the user's data privacy conditions and transactions conditions g. Using a central account for all users and a unique ID per transaction per user to shield the user ID and ensure that businesses don't build patterns of his usage.

In another broad aspect of the present technology, there is a UI/UX interface for users interests and privacy terms and conditions, comprising: a. Agent with multiple types/easy interfaces UI/UX, API, voice recognition to collect users' inputs b. Standard and customized terms and conditions for data privacy and interest. c. A platform that translates the user's privacy terms and conditions to smart contracts for exact execution d. A distributed ledger to record the data transactions and provide transparency.

In another broad aspect of the present technology, there is a UI/UX interface to invite business partners to join the trusted community/platform, comprising: a. Agent with multiple types/easy interfaces UI/UX, API, voice recognition to ask potential business partners to join the marketplace (trusted community) b. Business partners sign the user's data privacy terms and conditions (legal) c. A platform that translates the signing of user's privacy terms and conditions to smart contracts for exact execution d. A distributed ledger to record the data transactions and provide transparency

In another broad aspect of the present technology, there is a mechanism that allows the agent to be integrated with 3PP (POS system, Ecommerce websites) as a payment/loyalty point transaction option similar to Visa, Amex, Apple pay, etc. comprising and as a signing option (like Google, etc.) to protect data privacy: a. An API to be integrated with the 3PP application or POS. b. Protocol support and communication standards (NFC, etc.).

In another broad aspect of the present technology, there are terms and conditions for the user, protecting his consent, interests and rights and made for businesses to comply with to perform transactions and not solely to protect the businesses' interests, comprising: a. Terms and conditions written to protect the users' data privacy, intentions and details on users' data and business transactions. b. Terms and conditions written on behalf of the user, based on generic legal terms and specific customized to a single user conditions. They are easy to understand c. Businesses must comply with users' terms and conditions by signing the legal terms and conditions, to perform business on the marketplace d. Users don't need to sign businesses data rights that infringe on their privacy or not understand what businesses are doing with their data when performing transactions e. Users terms and conditions drafted by users' lawyers are protected by legal contract and DLT smart contract. f Smart contracts to complement the legal contract, and that will be executed to ensure we protect the user content g. DLT to ensure transparency and that no one alter the terms and other data

In another broad aspect of the present technology, there is a platform providing analytics based on user intentions and compliant with his data privacy terms and conditions, comprising: a. Matching business offerings with users' real intentions (obtained directly from them) b. Identity of the user remains anonymous c. Respecting the user's terms and conditions on data privacy d. Providing the business with real needs based on users' predefined intentions e. Showing the user, the offers he would like to receive, based on his pre-set conditions f. A smart contract platform that ensures that the user's data privacy conditions are protected, and the user receives offers based on his predefined interest g. A distributed ledger technology to record the transactions and provide transparency

In another broad aspect of the present technology, there is a platform providing businesses with real audience and true actionable users data, legally obtained, comprising: a. Users defined interests vs. machine guessing b. Compliance with users' data privacy terms and conditions and conditions (how to communicate with, when, by whom, about what, etc.) c. Sharing of Habits and data of the platform (marketplace and outside marketplace) users based on consent provide real insight for businesses. d. Possibility to trade data (business intelligence) about the platform (sum of users' transactions), excluding personal data or data from persons who didn't consent to this. This provides an opportunity for revenue sharing not at the expense of privacy and identity exposure.

In another broad aspect of the present technology, there is a mechanism that provides a platform for online and instore services/transactions, without infringing the reference to the user identity (privacy), comprising: a. A unique identity provided per user per transaction (Buys, search, deliver, receive advertising . . . ) online and instore. b. The agent acting on behalf of the user to perform these transactions and shield his/her identity. c. The platform keeps the user data locked and uses it to switch perform intermediary charges.

In another broad aspect of the present technology, there is a platform with a private marketplace and an outside marketplace (IAB platform, instore, etc.) for online and instore services/transactions, allowing the user to share only the personal data that he wants with the parties of his choice and the transactions of his choice on the marketplace and outside the marketplace (IAB platform, instore . . . ) comprising: a. Consent mechanism where the user can choose conditions for how/what/when to share his personal data with third parties. b. Identification of the type of parties that are not trusted, giving the user the transparency of whom he is interacting and knowing the risk that he might encounter. c. Connectivity with many trusted and non trusted platforms, IAB, world wide web, etc.

In another broad aspect of the present technology, there is a mechanism to provide transparency to users about the type of businesses and transactions they are performing in terms of data privacy, comprising: a. Classification of applications, service providers, search results and other transactions by Trusted semi-trusted or Not trusted b. Filtering and Listing applications, service providers, transactions based on user intention to deal only with trusted businesses or all c. Suggesting trusted alternatives for search results, transactions, service providers in addition to non trusted options d. Trusted means businesses don't have access to user data. Semi-Trusted means businesses have access to user data but signed legal terms and conditions. Non trusted means businesses have access to user data and didn't sign users' terms and conditions Different than today search engines or app stores based on how much they pay google search engine.

In another broad aspect of the present technology, there is a platform providing information, services and advertising to users based on their interest/consent and protecting their data privacy, comprising: a. An agent that gather from the user their interest in information, services and advertising and terms and conditions for their data privacy b. A smart contract platform that validates user's data privacy conditions and ensure that it is respected c. A smart contract platform that validates the user's intentions/interests and provides only the information, services and advertising that match with the interest d. A Distributed Ledger technology to record the transactions and provide transparency e. Business performing the advertising doesn't get any user data f Showing the user, the classification of the business (Trusted semi-trusted or Not trusted) in the response. g. Providing a unique temporary ID for this transaction, to ensure that no business can guess the identity of the user h. Providing two ways to implement: Business initiates the offer, or the platform initiates the demand/interest and then the business initiates the offer. i. Advertising applies to services or products

In another broad aspect of the present technology, there is a mechanism to receive and view advertising without exposing user's identity and by protecting his data privacy, comprising: a. The template used to fill the business advertising information, is static and doesn't include cookies and other scripts that will collect the user identity and personal data. b. Remote control capability to view the advertising information remotely from the platform/agent interface (Ex: web browser) c. The platform performing the matching between the business offer and user demand in compliance with user's privacy.

In another broad aspect of the present technology, there is an anonymous shipping methodology comprising: a. An agent that protects the privacy of the receiver by acting on his behalf to order and receive goods/products. b. A unique ID (RFID) (issued once per number of transactions that doesn't expose the user habits) that is used to identify the user to claim the products, without providing any personal data c. A distributed ledger technology to record the transactions and provide transparency d. The agent can validate the ID of the shipping transaction for this user and send the confirmation to the user and business. e. A smart contract platform that complies with the user's data privacy conditions and shipping delivery preference.

In another broad aspect of the present technology, there is an anonymous service acquisition (such as restaurant reservation) methodology comprising: a. An agent that protects the privacy of the receiver by acting on his behalf to order services. b. A unique ID (RFID) (issued once per transaction) that is used to claim the services, without providing any personal data c. A Distributed Ledger technology to record the transactions and provide transparency d. The agent can validate the ID of the shipping transaction for this user and send the confirmation to the user and business. e. A smart contract platform that complies with the user's data privacy conditions and service delivery preference.

In another broad aspect of the present technology, there is provided one single loyalty program for all business transactions performed on the marketplace (online and instore) with data privacy, comprising: a. One unique loyalty point system used for all different businesses and industries using the same platform b. A smart contract platform that validates the conditions of the points system and ensures respect of the user data privacy terms and conditions c. The user doesn't need to provide his data to the business to get access and use loyalty program d. A Distributed Ledger technology to record the transactions and provide transparency.

In another broad aspect of the present technology, there is provided a loyalty point program based on a revenue sharing model on the marketplace, comprising: a. Methodology to share revenues when accessing user data, based on their consent b. Smart contracts to ensure that loyalty points are transferred based on pre-set conditions. c. A ledger to ensure that loyalty points are not altered.

In another broad aspect of the present technology, there is an anonymous payment methodology for online (in the marketplace) and instore (outside the marketplace) protecting user's data privacy and credit card theft, comprising: a. An anonymous card or application for instore payment b. Online payment methodology for Ecommerce transactions c. Payment to be performed by an agent using a central payment method without exposing the user information. The business will know only the identity of the agent (central) without knowing on who's behalf is it made. d. Each transaction will be identified by a unique ID, that is not traceable to any data of the user e. Based on user preferences, each transaction can be validated (based on pre-set conditions) before it is completed using smart contract conditions. f. User has transparency on all transactions as they will be stored in DLT. Traceability of payments and debit/credit between platform and users' account.

In another broad aspect of the present technology, there is an anonymous loyalty point system for online (in the marketplace) and instore (outside the marketplace) protecting user's data privacy and theft, comprising: a. An anonymous card or application for instore loyalty usage b. An algorithm to randomly select a loyalty card number from a pool of cards owned by the platform per transaction and to assign it to a user per transaction. c. A way to use token mechanism, such as in payment cards. d. Online loyalty point methodology for Ecommerce transactions e. Loyalty points will be collected by an agent using a central loyalty point method without exposing the user information. The business will know only the identity of the agent (central) without knowing on who's behalf is it made. f Each transaction will be identified by a unique ID, that is not traceable to any data of the user g. Based on user preferences, each transaction can be validated (based on pre-set conditions) before it is completed using smart contract conditions. h. User has transparency on all transactions as they will be stored in DLT. Traceability of loyalty points between platform and users' account for debit and credit purposes.

In another broad aspect of the present technology, there is a tokenization methodology that provides complete user data privacy for payments, loyalty points systems and other card transactions, from any business player in the payment/loyalty points/digital transaction chain, comprising: a. Centralized tokenization mechanism, performed by the platform with the issuer of the tokens (bank, loyalty card issuer . . . ). b. The platform sends the tokenized number to the user application (digital wallet, etc.) where it will be stored for transaction. c. Tokenization using multiple real cards (credit cards, loyalty points.) that are assigned/shared to/by different users frequently so businesses can't track a token to one user. d. Tokenization and real card number rotation between the platform users is done frequently (by transaction, day, week . . . ) to avoid the bank businesses learning about individual users' data/habits. Businesses will only have the data about the platform but not individual users.

In another broad aspect of the present technology, there is a system that provides the agent detailed information about the transaction (payment, loyalty point system . . . ) that would be relayed to the platform to perform the right tracking of the transaction by user without infringing on the user data privacy, comprising: a. A method where, the POS sends the detailed transaction information amount to the agent/platform before sending it to the bank/loyalty point system b. Another method where the issuer bank sends the information to the platform prior to executing the transaction. c. The right tracking of the transaction to the user for chargeback or credit (money, loyalty points . . . ) between the platform or warranty, insurance, etc. d. Some of this transaction Information will be stored in the DLT for transparency and to avoid any tampering e. Some of the transaction information will be used to execute smart contracts, such as approve payment by agent to the merchant or charge back the user account by the platform.

In another broad aspect of the present technology, there is a system providing remote access/control to browsers to perform transactions (search for content, etc.) in an anonymous way and without getting unwanted advertising, comprising: a. Mirroring of the browser at the user end b. IP endpoint is at the central platform and not at the users. This will prevent content owners and advertisers from knowing the user IP address, location from advertising to him without his consent and from getting his data. c. Encryption tunnel for communication between the platform and the end user. d. Agent will perform activities in the browser on behalf on behalf of the user, protecting his identity. e. User gets remote control capability and link to the Search & read agent (browser, etc.) f. Searches can happen in the private community (marketplace) and outside the marketplace.

In another broad aspect of the present technology, there is a mechanism to provide the user and law enforcement transparency on the business transactions and data transactions to meet legal requirements and visibility, comprising: a. Smart contract that satisfies certain conditions (Ex: warrant, user's fingerprint . . . ) will kickoff an API to show the data. b. Access to the data is also tracked and stored on the DLT.

In another broad aspect of the present technology, there is a mechanism to automate the agreement for the Buy and Sell process without infringing on the user identity and data privacy, comprising: a. A smart contract is created with the price and condition agreed. This is what will be executed automatically. b. The identity is kept private. Only the temporary ID is known, but it is not linked.

In another broad aspect of the present technology, there is a platform providing information (search and ask), to users based on their interest/consent and protecting their data privacy, comprising: a. An agent that gather from the user his interest in information and terms and conditions for his data privacy b. A smart contract platform that validates user's data privacy conditions and ensure that it is respected c. The agent receives the information on behalf of the user, validates its compliance with data terms and conditions and validate that there are no cookies that jeopardize the user data privacy . . . d. Provide remote control capability to view the result from the agent/platform interface without exposing his identity. e. AI/Analytics can be used to filter search results before providing them to the user (based on accuracy and other criteria) f A Distributed Ledger technology to record the transactions and provide transparency g. Business who provided the search result doesn't get any user data h. Showing the user, the classification of the business (trusted, semi-trusted or, not trusted) in the response. i. Providing a unique temporary ID for this transaction, to ensure that no business can guess the identity of the user.

In another broad aspect of the present technology, there is a temporary ID is generated randomly for the user for a transaction or a series of transactions to protects the user's data privacy, comprising: a. Temporary ID generator with an algorithm to generate randomly 1 unique ID for the user for the transaction or transaction series. b. Only this ID is communicated to other parties (businesses . . . ) but o personal data c. Provide tracking of the ID vs. the transaction in the DLT.

In another broad aspect of the present technology, there is a mechanism to provide the user with an email communication system that protects the user's identity and protects him from any unwanted communication (i.e. spam, advertising), comprising: a. A temporary email address that is generated by the platform once per transaction or per communication channel (i.e. 1 email per business he is communicating with) for both incoming and outgoing email. b. Analytic/AI functionality to analyse the incoming emails and filter out spam or unwanted advertising prior to sending it to the user.

In another broad aspect of the present technology, there is a solution that provides businesses marketing campaign results, based on real numbers without sharing any personal data on the users, comprising: a. Statistics on the marketing campaign based on information gathered from the platform, DLT, based on users' real interest. b. User identity is protected by unique temporary ID and by the agent perform the transaction on behalf of the user.

In another broad aspect of the present technology, there is an agent for protecting the privacy of end-users of business transactions, comprising: a. a network interface adapted for communicating with one or more end-users and with one or more business-users; b. a database adapted for storing: i. a respective identity and an account for each of the one or more end-users, and ii. terms of contracts established with each of the one or more business users; c. a controller operatively connected to the network interface and to the database, the controller being configured to: i. receive from one of a given end-user a request to anonymously purchase an item from a given business user, ii. in response to receiving the request to anonymously purchase the item from the given end-user user, generate a temporary identity for the end-user and transmit the request to the given business user using the temporary identity, iii. receive an acknowledgement from the given business user, the acknowledgement carrying the temporary identity, iv. provide a payment according to the terms of the corresponding contract to the given business user, v. obtain a purchase receipt from the given business user, vi. debit the account of the given end-user, and vii. inform the given end-user that the item has been purchased.

In another broad aspect of the present technology, there is a method for performing a transaction between a customer and a business, the method comprising: receiving a set of terms corresponding to the customer; receiving, from the customer, an offer corresponding to the transaction; generating, based on the set of terms and the offer, a smart contract corresponding to the transaction; generating a user ID corresponding to the customer to be used during the transaction; transmitting, to the business, the offer and the user ID; receiving, from the business, a confirmation that the business has accepted the offer; after the offer has been accepted, executing the smart contract corresponding to the transaction; and recording, on a digital ledger, a record of the transaction.

In some embodiments, the set of terms corresponding to the customer comprise privacy preferences of the customer.

In some embodiments, the offer comprises an indication of an item or service and a price.

In some embodiments, the user ID is unique to the transaction.

In some embodiments, the method further comprises transmitting, to the customer, an indication of whether the business is a trusted business.

In some embodiments, the method further comprises selecting a loyalty card number corresponding to the customer; transmitting the loyalty card number; generating a smart contract corresponding to the loyalty card number; and executing the smart contract.

In some embodiments, executing the smart contract causes loyalty points to be deducted from an account corresponding to the business and added to an account corresponding to the loyalty card number.

In some embodiments, the method further comprises sending a token indicating that the transaction has been completed to the customer.

In some embodiments, the method further comprises sending a token indicating that the transaction has been completed to the business.

In another broad aspect of the present technology, there is a method for fulfilling a transaction between a customer and a business, the method comprising: receiving an indication that the customer purchased a product or service; generating a user ID corresponding to the customer to be used for fulfilling the transaction; storing, on a distributed ledger, the user ID; receiving, via a user interface, a request from the customer to receive the product or the service; validating, by a smart contract, that the user ID corresponds to the transaction; sending, to the business, a notification that the transaction has been validated; receiving, from the customer, a confirmation that the transaction has been completed; after receiving the confirmation, completing a smart contract corresponding to the transaction; and storing, on the distributed ledger, an indication that the transaction has been fulfilled.

In some embodiments, receiving the indication that the customer purchased the product or the service comprises receiving, via the distributed ledger, the indication.

In some embodiments, receiving the request from the customer to receive the product or the service comprises receiving an indication that the customer is in a physical location corresponding to the business.

In some embodiments, sending the notification that the transaction has been validated comprises sending an indication of the user ID to the business.

In some embodiments, the method further comprises sending a token indicating that the transaction has been completed to the business.

In another broad aspect of the present technology, there is a method for providing advertising to users, the method comprising: receiving, from a business, a request to advertise an offer; receiving a set of privacy conditions corresponding to the business; generating, based on the offer and the set of privacy conditions, smart contracts corresponding to the offer; storing the smart contracts on a distributed ledger; generating, based on the offer and a template, an advertisement; executing the smart contracts to determine a set of users to provide the advertisement to; determining, based on preferences corresponding to each user of the set of users, a method of delivering the advertisement to the respective user; receiving indications of user interactions with the advertisement; storing the indications of user interactions on the distributed ledger; generating, based on the smart contracts and based on the indications of user interactions, advertising results; and sending the advertising results to the business.

In some embodiments, the request comprises an indication of a product or service, a price, and terms of the offer.

In some embodiments, executing the smart contracts comprises identifying users with privacy settings that are compatible with the set of privacy conditions.

In some embodiments, executing the smart contracts comprises identifying users with interests corresponding to the offer.

In some embodiments, sending the advertising results to the business comprises sending anonymized data to the business.

In some embodiments, the advertising results comprise an amount of users that interacted with the advertisement.

In the context of the present specification, a “server” is a computer program that is running on appropriate hardware and is capable of receiving requests (e.g. from client devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server.”

In the context of the present specification, “electronic device” may be any computer hardware that is capable of running software appropriate to the relevant task at hand. In the context of the present specification, the term “electronic device” implies that a device can function as a server for other electronic devices and client devices, however it is not required to be the case with respect to the present technology. Thus, some (non-limiting) examples of electronic devices include personal computers (desktops, laptops, netbooks, etc.), smart phones, and tablets, as well as network equipment such as routers, switches, and gateways. It should be understood that in the present context the fact that the device functions as an electronic device does not mean that it cannot function as a server for other electronic devices. The use of the expression “an electronic device” does not preclude multiple client devices being used in receiving/sending, carrying out or causing to be carried out any task or request, or the consequences of any task or request, or steps of any method described herein.

In the context of the present specification, “client device” is any computer hardware that is capable of running software appropriate to the relevant task at hand. Some (non-limiting) examples of client devices include personal computers (desktops, laptops, netbooks, etc.), smart phones, and tablets, as well as network equipment such as routers, switches, and gateways It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “software component” is meant to include software (appropriate to a particular hardware context) that is both necessary and sufficient to achieve the specific function(s) being referenced.

In the context of the present specification, the expression “computer information storage media” (also referred to as “storage media”) is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” may be any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first database” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware components, in other cases they may be different software and/or hardware components.

Implementations of the present technology may each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1a is a diagram of a business transactions process performed by an agent on behalf of a user according to some embodiments of the present technology;

FIG. 1b is a flow diagram of a method for account creation and registration on the agent according to some embodiments of the present technology;

FIG. 2 is a flow diagram of a method for requesting business to register on an app to have a central way to access user data and to protect user data privacy according to some embodiments of the present technology;

FIG. 3a is a flow diagram of a method for searching and asking questions online in an anonymous way without exposing the identity of the user according to some embodiments of the present technology;

FIG. 3b is a flow diagram of a method for searching and asking questions instore in an anonymous way without exposing the identity of the user according to some embodiments of the present technology;

FIG. 4a is a flow diagram of a method for a business initiating advertising according to some embodiments of the present technology;

FIG. 4b is a flow diagram of a method for platform initiated advertising according to some embodiments of the present technology;

FIG. 4c is a flow diagram of a method for business initiated advertising in an open community according to some embodiments of the present technology;

FIG. 4d is a flow diagram of a method for platform initiated interest in an open community according to some embodiments of the present technology;

FIG. 5a is a flow diagram of a method for buying and selling online in a trusted community according to some embodiments of the present technology;

FIG. 5b is a flow diagram of a method for buying and selling online in an open and non-trusted community according to some embodiments of the present technology;

FIG. 6a is a flow diagram of a method for registration on a pay and go application according to some embodiments of the present technology;

FIG. 6b is a flow diagram of a method for a transaction in an open community on the pay and go application according to some embodiments of the present technology;

FIG. 6c is a flow diagram of a method for a transaction in an online trusted community on the pay and go application according to some embodiments of the present technology;

FIG. 6d is a flow diagram of a method for a transaction in a store on the pay and go application in which the point of sale (POS) device sends the transaction details according to some embodiments of the present technology;

FIG. 6e is a flow diagram of a method for a transaction in a store on the pay and go application in which the issuing bank sends the transaction details according to some embodiments of the present technology;

FIG. 7a is a flow diagram of a method for shipping and receiving products and services in a trusted marketplace according to some embodiments of the present technology;

FIG. 7b is a flow diagram of a method for shipping and receiving products and services in an open community according to some embodiments of the present technology;

FIG. 7c is a flow diagram of a method for sending and receiving email according to some embodiments of the present technology;

FIG. 8 is a flow diagram of a method for trading data according to some embodiments of the present technology;

FIG. 9 is a flow diagram of a method for identifying a type of business in relation to data privacy according to some embodiments of the present technology;

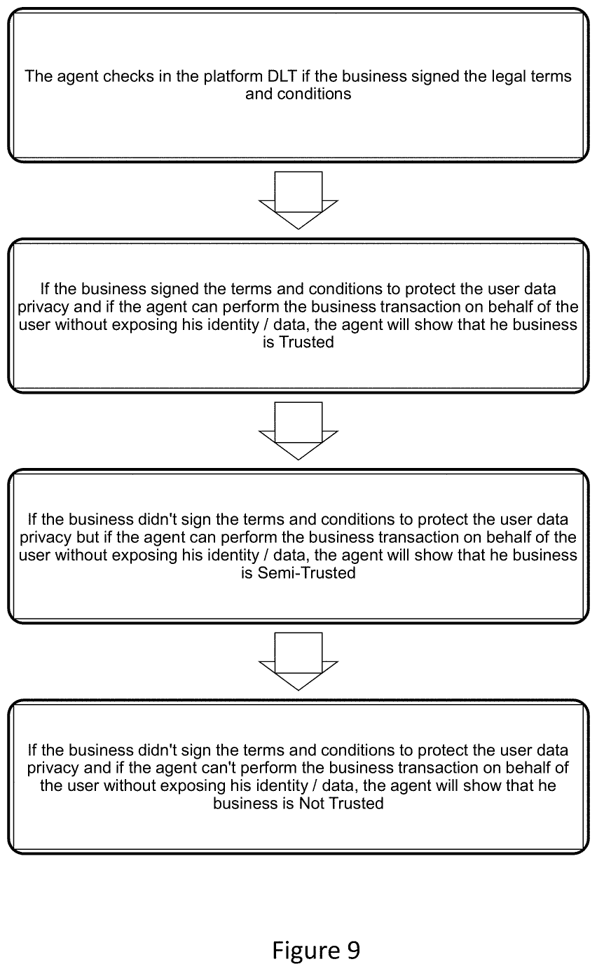

FIG. 10a is a flow diagram of a method for viewing user data according to some embodiments of the present technology;

FIG. 10b is a flow diagram of a method for viewing user data based on legal proof according to some embodiments of the present technology;

FIG. 11 is a block diagram of a system for implementing non-limiting embodiments of the present technology; and

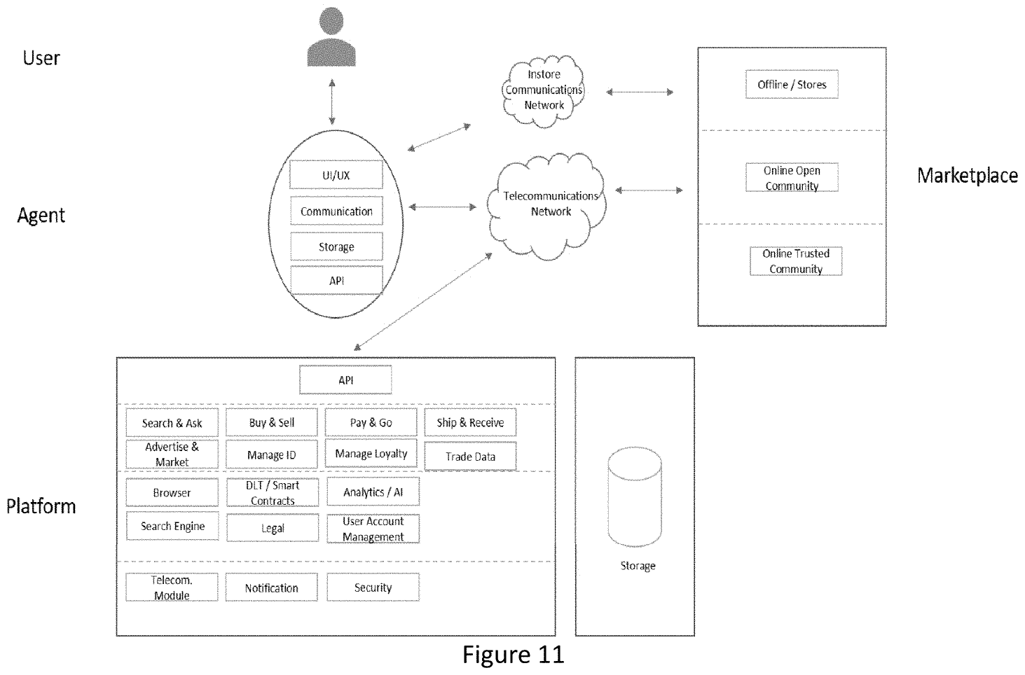

FIG. 12 depicts a schematic diagram of an example computer system for implementing non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application-specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

The exemplary embodiments described herein provide a system that may protect the privacy of users across the whole supply chain and steps of business transactions, such as when searching for a product/service, advertising/marketing, agreement to buy/sell, making a payment, receiving goods/services, and/or gathering loyalty points. This protection in the end to end process may prevent or reduce the likelihood of leakage of the users' personal data. The user may be a consumer or a business. The role of an individual can change based on the transaction. The individual can be user in one type of transaction (for example a buy transaction) and take the role of the business in other transaction (for example a sell transaction).

The systems and/or methods described herein may be used when performing business transactions online, in a private trusted community, in a non-private/non-trusted community (world wide web), and/or in-store. The systems and/or methods described herein may be compatible with and/or incorporate existing processes and mechanisms, such as POS terminals, credit cards, loyalty cards, etc.

The systems and/or methods described herein may protect the user's personal data and/or provide the user full control of their personal data by providing a central and unique ownership, storage, access, terms/conditions and reporting. The legal terms and conditions may be written to protect the user's privacy, rather than being written solely to benefit the business. They may be written once, understood by the user once, and then used for all different businesses the user deals with. The terms and conditions are legal contracts that may also be translated into smart contracts, executed on behalf of the user for all business transactions.

Businesses may sign the legal terms and conditions to protect users' data privacy when performing a business transaction with the user and not the other way around. The user can send an invitation to businesses to sign the terms and join the private community, if the business would like to perform business transactions with users in that community.

An agent, with different types of interfaces (API, voice recognition, application UI/UX . . . ) performs business transactions on behalf of the user online and in the store by hiding the user identity and protecting its data privacy. The agent may use temporary IDs, which may be generated frequently, to prevent businesses from doing cross-referencing and guessing user's identity.

The agent may interface with the businesses to perform all business transactions on behalf of the user: search, advertise/market, make an agreement to buy or sell, pays, receives goods/services and/or collect loyalty points. On the other hand, he may share the results of his business transactions with the user in accordance with the user's terms/conditions and interest. He may chargeback or credit the user based on the payment and loyalty points transactions and deliver the products/services to the user.

The agent may identify the type of businesses and transactions in terms of data privacy trust to make the user aware prior to performing a transaction. Businesses can collect only data about the platform and not the user. It is possible to share analytics and data about the platform (sum of users) and users can benefit from a revenue sharing model, without exposing their personal data directly.

This system may block businesses/users from collecting, stealing, and/or profiling users without clear consent or without the user's knowledge. Users may receive accurate advertising, based on their interests, minimizing fraud and manipulation. Analytics and AI can be used to provide accurate results for searches, reducing fake information, based on payment systems.

Companies may be prevented from selling a user's data without the user's consent. In fact, the only data that businesses may be able to collect is the platform's (sum of the users). Users might not need to sign a business's terms and conditions, but the businesses may be forced to sign the user's terms.

The user might not need to sign multiple different businesses terms and conditions that the user may not even understand, but on the contrary businesses may need to sign the user's terms and conditions (legal contract). These terms and conditions may be drafted by a legal entity in order to protect the user's privacy. In addition, the agent provides the user with transparency on the type of businesses (trusted, or not trusted) that he is about to perform the transaction with.

The agent may perform digital transactions that occur in a private community/marketplace (i.e. ecommerce site) and outside the private community (i.e. 3PP websites). In addition, the agent may perform transactions in the store.

The agent may have different types of interfaces to interact with the user and the businesses. The agent may be a robot agent and/or a wearable device with voice recognition and command system. The agent may be an application that could be downloaded from application stores (i.e. Apple, Android) on a user/business device.

The agent may have API capabilities that can be integrated in applications and with ecommerce and websites to perform digital transactions. The agent may use digital keys issued per transaction (i.e. RFID based) to ensure that user identity is protected when making payments or receiving products and services

The system may also include a private community (marketplace) with users and businesses who have signed data privacy terms and conditions (legal contract). These legal terms may also be executed automatically as smart contracts to protect user data. The private community members may be considered as trusted because they have signed a legal contract and smart contracts may be executed to protect users' data privacy, consent, interests, and/or terms and conditions.

The system may provide access to an online community outside the private community (i.e. search engines) or instore. The businesses on this non private community may be considered semi trusted, because they did not sign the terms and conditions (legal document), however the agent is acting on the user behalf to protect his identity and smart contracts exist in place.

There may be instances when the business is non trusted. This is the case when the business did not sign the legal terms and conditions and, if the user wants to perform a transaction with the business, the agent may be unable to protect the user's identity

### Registration

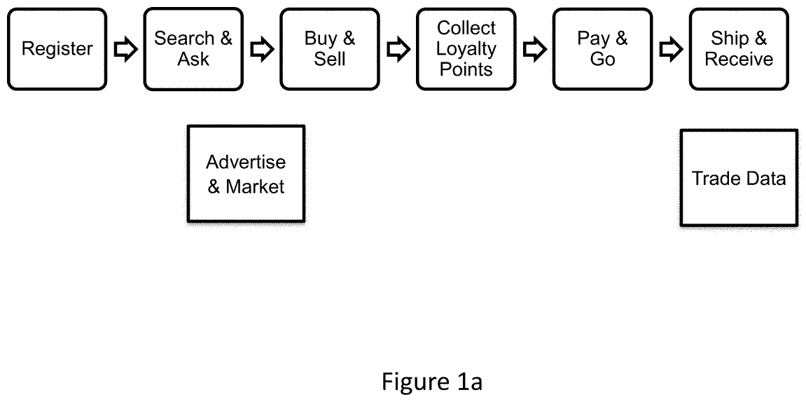

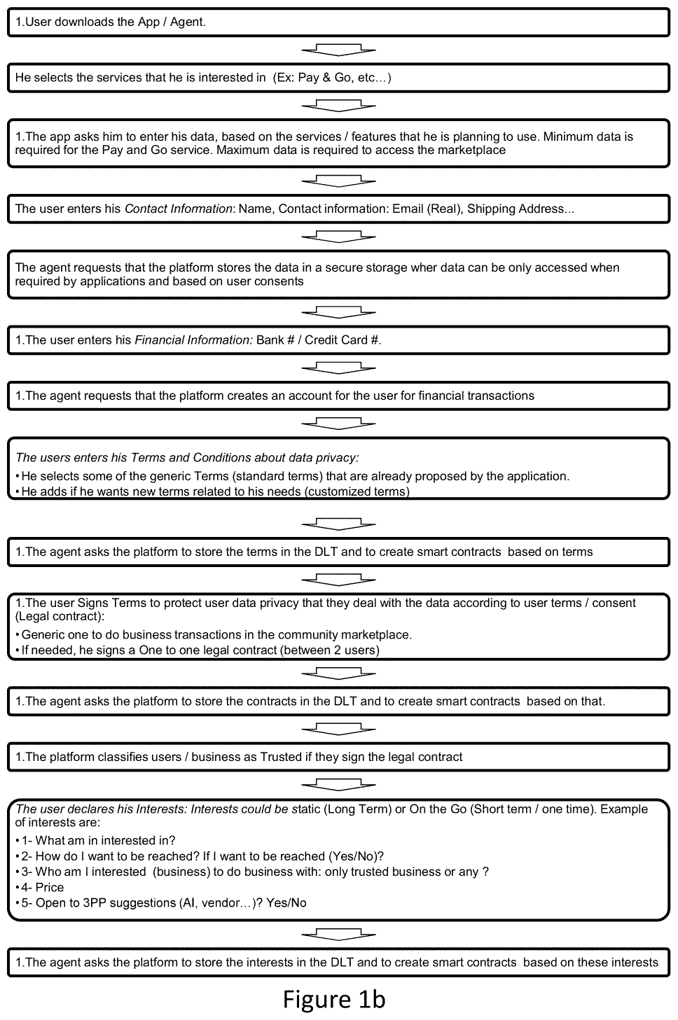

FIG. 1b is a flow diagram of a method for account creation and registration on the agent according to some embodiments of the present technology. First the user registers with the agent and the platform.

The user may only provide the minimum information required by the application/feature that he wants to use. The data entered could be for a one-time use (dynamic) or multiple times (static). The data may be centrally stored and controlled by the user.

The agent may provide a central, secure and unique storage of the users' personal data, for all business transactions, on the marketplace and outside the marketplace. In addition, the agent may provide the user the right to choose what data to share, when and with whom and the transparency on his data transactions (who accessed the data, when, what purpose, etc.).

There might not be a need to provide businesses the data to store at their own premises or data lakes. Rather, businesses may be able to access the central data storage provided by the agent according to the users' terms. The only data that may be accessed by the business is the minimum required data to perform the business's transactions, based on users' requirements.

There are multiple types of data:

### 1) Identification

### 2) Contact Information

3) Financial to pay back or get credited for all the services the user uses or offers.

### 4) Consent

5) Terms and conditions for data usage: Generic terms or customized
6) Interest: Static or dynamic

The user may sign the terms and conditions to perform business transactions with other users on the platform. The agent/platform may create an account for the user chargeback/credit for financial and loyalty points transactions.

The agent may use Digital Ledger Technology to register the history of data transactions and/or digital transactions in an immutable way, to provide transparency to the user and other stakeholders and to execute smart contracts based on user consents, interests in advertising and conditions for the execution of digital transactions.

The agent may classify users and businesses in different categories (Trusted, Not Trusted and Semi-Trusted) for data privacy, in the context of business transaction. Classification may be done after validation if the user/business signed the legal terms, on the Digital Ledger. This classification may be provided to users to give them the visibility of who they are dealing with prior to taking any action.

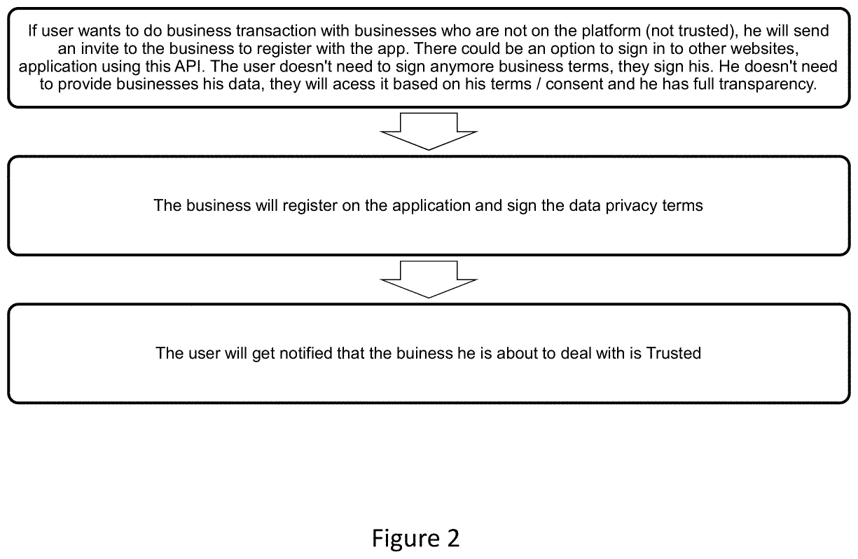

Users can invite businesses or other users to sign the terms and conditions and join the trusted community. FIG. 2 is a flow diagram of a method for requesting business to register on an app to have a central way to access user data and to protect user data privacy according to some embodiments of the present technology.

### Search/Request

The user can request the agent to perform a search/ask transaction on his behalf by keeping his identity and personal data private. In addition, he can view the results remotely without his identity or information being exposed to the publisher.

The user may set his interest and terms and conditions of the search: he can specify the topic of search, where to do the search, when, how to receive the search information and by whom. In addition, the user can specify the search location: online in the private community or non private community and offline, in the store. He can select the type of publishers: Trusted, Semi-Trusted, Not Trusted or any. He can request that the results be provided raw, as is, or analyzed by the agent (analytics) to provide him real information (not provided by publishers who paid more), that matches with his interests. The topic of search could be a preconfigured interest (static) or a new topic that the user identifies per time (dynamic).

The agent may identify the type of the source of information (publisher) Trusted, Semi-Trusted and non-Trusted and includes it with the answers to the user. This provides visibility to the user so he can take the right decision. The agent will have different interfaces to communicate with the online publishers/stores, to perform the search online and offline (Ex: browser, RFID, etc.).

The agent may save, on the distributed ledger technology (DLT) platform, the history of specific information about the transactions for legal purposes and for users' transparency. This information might not be used for other reasons, unless specified by the user. The user identity and data may be shielded by the agent who will act on the user's behalf to perform a search and/or to view the information.

The agent may ensure that the business/publisher who is providing the search results does not gather personal data about the user without the user's consent or by forcing the user's consent as a price for the information.

The user may be provided a temporary ID, token unique per transaction or changed at a frequency that may prevent businesses from gathering any personal data or identifying the origin of the user who is performing the search or view. It might not be possible to cross-reference and build profiling data on the user. The business may only collect data on the agent (sum of multiple users) but not a single user. The online data that could be sold or stolen is the agent data and it does not include the user private data.

Using this method, a search can be performed with privacy, not only in the private community, but also online, in the public community and offline, in the store. The user may be given remote control to the agent interface (Ex: browser, voice recognition) to request the search or view the search result, without exposing his identity and personal information.

For transactions that occur in the private/trusted community, the agent may validate the user consent/interest and may let the user view the advertising if the user provided his consent and the advertising matches with his interest. The search results may be provided to the user in accordance with his interest (when to receive information, where, etc.).

### Advertise and Market

If the business is a member of the trusted community, it can request the agent to perform advertising/marketing efficiently, to users who showed interest in this type of advertising and who consented to advertising. This will help them perform efficient advertising/marketing, based on real users/interests and compliant with data regulations (Ex: GDPR).

On the other hand, the user can request the agent to send him advertising/marketing that matches with his interests and based on his conditions (when to receive the information, where to receive the advertising information, what businesses can send him advertising, etc.) without sharing his identity or his personal data.

Users can provide the agent with their interest in terms of products, services, businesses they would like to work with, price, etc. In addition, they can enter their conditions for communication, data privacy, etc. This can be static (Ex: for LT) or dynamic (Ex: one-time use).

Businesses can communicate to the agent their intention to offer products/services with a price. On the other hand, the agent could also send businesses, the community users' interests, so they can prepare their offers accordingly.

The agent uses analytics/AI capabilities to match the business's offers with users' interests and sends the results to the community members (users) after validating their terms and conditions. The agent may provide details on the source of the advertising, in addition to the privacy type (T, ST, NT). The communication of the offers with the interested users may comply with the user terms and conditions (Ex: email, application notification, etc.).

The business may be informed of the steps and number of users reached, without providing personal information about the users, nor their personal identity. Businesses can be online (trusted or non trusted community) or stores who have omnichannel capabilities to connect online. These systems and methods may also apply to ambient advertising.

The user's identity may be protected in advertising/marketing. The business identity could be also protected if needed. Users' data might not be shared with businesses. Businesses don't need to use strategies that don't comply with data privacy regulations, to guess users interests of a community. The agent can provide them that information. Businesses may be able to know the real interest in their products and thereby perform better forecasting. This strategy may provide efficient advertising/marketing campaign (real interest) for businesses rather than what they were getting from the traditional IAB system that was measured on clicks, viewers that were not real numbers in some cases.

The agent may only provide users' interests information, based on smart contract conditions that comply with users' interest and terms and conditions. The process may be automated to avoid any action that does not comply with users' terms. The user alone has the potential to change these conditions and history is logged on a DLT platform to avoid anyone tampering with the data.

A user may only receive advertising/marketing if he wants and he will only receive the information that he is interested in. Users can dictate the conditions of how to be contacted and by whom (for example they can blacklist certain companies if they want). Users have the choice to choose AI/analytics capabilities to suggest advertising in addition to their defined interest. Users will have transparency of all their advertising/marketing transactions (for example dates, time, agent send interest on their behalf, etc.).

### Buy and Sell

The user can request the agent to send an offer to buy a product/service online on his behalf by keeping his identity and personal data private. The business can request the agent to send an offer to sell a product/service online, to the users who match the interest. They can choose to keep their identity private.

The agent will provide offers and counteroffers from the user to business and vice-versa. These offers and counter-offers are registered on the DLT ledger to ensure no one tampers with the information. Offers and counter-offers can be executed automatically by the agent by using smart contracts that are based on users and businesses conditions.

Once a deal is reached, the conditions of the deal are saved as a smart contract that will be executed automatically for price, delivery, service scope, loyalty points and other conditions.

The user is provided a temporary ID, token unique per transaction or changed at a frequency that makes it impossible for businesses to gather any personal data or to identify the origin of the user who is performing the Buy and Sell transaction.

User and data are kept private across the whole process. Offers and counter-offers are processed according to the agreed terms automatically to avoid fraud and to avoid any party not complying with the agreed terms. This use case applies in the online trusted and non trusted community.

### Pay & Go

The user can request the agent to pay on his behalf online or in the store, by keeping his identity and personal data private. The agent will use a payment card (credit card) that is provided by the platform to perform payment over the regular POS system instore. Payment can be done by the agent application/digital wallet.

In addition to the digital wallet, the agent can use an integrated payment method by the ecommerce website. A centralized private payment method may be used online in the trusted community. The agent may provide the user the option to validate the transaction (amount, business . . . ) prior to making the payment. This may help minimize fraud.

For payments outside the private community, the system uses an algorithm to assign from multiple payment cards (credit/debit cards), one for the user. The payment cards are owned by the agent/system. Once the payment card is assigned by the system, the agent requests and stores the token that is provided by the issuing bank in the user's digital wallet. This is done frequently to ensure that none of the businesses from the payment supply chain (banks, payment network, retail business, etc.) can identify the user or can guess or cross-check his identity. In addition, they might not be able to gather any personal data on the user who will keep the same user experience as he has today. Data will be only gathered on the agent, the owner of the payment card.

Prior to making the payment, the agent may validate with the user, the transaction (such as by providing the transaction amount and name of the business) and stores the confirmation on the DLT, which will kickoff the execution of a smart contract to debit the user's account and credit the agent's account with the business transaction amount. This may minimize fraud and ensure transparency and uncontested transactions between the user, agent and business.

The agent can use two methods to validate the transaction with the user and perform internal accounting between the agent and the user (deduct from the user's account the amount), prior to making the payment to the business:

1) The transaction information (amount, name of business, etc.) will be sent by the POS/business to the agent, prior to executing the payment operations.
2) The agent payment card issuing bank will send the transaction information to the agent prior to executing the payment transaction.

The agent can be integrated with websites or applications as a payment option for better user experience. The agent may use a temporary ID to identify the user when performing the pay and go transaction online. This temporary ID is used to track the transaction in the trusted platform (agent, system and user) but it is provided at a frequency (such as per transaction) to ensure that the business cannot identify the user.

### Loyalty Points

Collecting loyalty points is very similar to payment. The user can request the agent to collect loyalty points on his behalf online or in the store, by keeping his identity and personal data private. The agent will use a loyalty point card that is provided by the platform to collect points over the regular POS system instore. Point collection can be done by the agent application/digital wallet.

In addition to the digital wallet, the agent can use an integrated loyalty point method by the ecommerce website. A centralized private loyalty point method may be used online in the trusted community.

The system may use an algorithm to assign from multiple loyalty cards, one for the user. The loyalty cards are owned by the agent/system. Once the loyalty card is assigned by the system, the agent requests and stores the token that is provided by the issuing loyalty card business in the user's digital wallet. This is done frequently to ensure that none of the businesses from the loyalty card supply chain (loyalty card issuer, retail business, etc.) can identify the user or can guess or cross-check his identity. In addition, they might not be able to gather any personal data on the user who will keep the same user experience as he has today. Data will be only gathered on the agent, the owner of the loyalty card.

After performing the loyalty point transaction, the agent may send the user the transaction (for example number of points, name of business) and stores the confirmation on the DLT, which will kickoff the execution of a smart contract to credit the user's account and debit the seller's account with the loyalty transaction amount. This may minimize fraud and ensure transparency and uncontested transactions between the user, agent and business.

The agent may use a temporary ID to identify the user when performing the loyalty point transaction online. This temporary ID is used to track the transaction in the trusted platform (agent, system and user) but it is provided at a frequency (for example per transaction) to ensure that the business can't identify the user.

### Ship and Receive

The business/user can request the agent to ship/receive products/services on his behalf, by keeping his identity and personal data private. The user can request to send the product to a neutral address (such as a mailbox) or he can request to pickup the product or receive the service (such as a restaurant reservation) in-store.

The user's “ship and receive” preference can be translated into a smart contract that can be automatically executed after the pay & go transaction. The agent may provide a unique ID in a secure way (such as encryption) to the user and the business for that shipping transaction. The ID can be read and compared by a device (such as using RFID).

The user can present the ID to the business to validate that he is the owner of the product or the service, by comparing the IDs. The business uses the agent to validate the ID.

These techniques may ensure that the user keeps his privacy when receiving a product or service. Businesses might not be able to determine the identity of the user, but they can validate that he is the owner of the product or service. The user/business doesn't need to share their address for security reasons or protecting their data privacy.

On the other hand, the user can use the agent email address to register for a service (such as a conference, restaurant reservation, etc.) without exposing his identity. The agent may send emails or receive emails on the user's behalf without exposing his identity. The agent may then forward the emails to the user based on his terms and conditions.

### Trade Data

The user can consent that his pseudonymous data be part of the agent data that could be provided to businesses for forecasting, advertising, etc. This is an opportunity for revenue sharing without exposing personal data or identity. The agent can share statistics such as number of products, used by him (sum of all users), to businesses based on conditions (such as trusted business, no spamming, etc.) without exposing the users' identity or personal data. Only the agent data may be exposed.

The data shared could be coming from interest and user consents and be efficient. Users might not need to expose their data to make revenue. Revenue sharing could be a credit to use for some products/services online and in the store. The platform can sell analytics services to businesses without infringing users' consent and without showing users' identities and users can get paid for it. This marketplace could be used for data transactions such as health companies that want to do research using users' data. This could be done based on user data of users who gave consent.

### View Data

The user can, at anytime, access the agent to view the history of his data and business transactions. For example, he can view who accessed his data, what data, when and for what reason. In addition, law enforcement users can also access at anytime the agent to view the history of users' data and business transactions after they validate their legal requirements.

### System Architecture

The system is composed of an agent, a platform and a marketplace. The agent can be a standalone device (portable, wearable) with an application (such as a digital wallet) on that device or it could be an application (such as a digital wallet) downloaded on the user device (smart phone, wearable device (such as a watch, iPad, fitness tracker, etc.).

The agent's application can be downloaded from an application store (Ex: Apple store, Android) or from a website. The agent's application may have the following modules: UI/UX interface module, communications module, storage module, and/or API module.

UI/UX interface Module: To communicate with the user and the business, as the agent acts as an intermediary between the two to perform a business transaction. The UI/UX interface allows two way communication between the user/business and the agent. Users will have an easy way to access a menu of business transactions' options to choose from. It will be also used to enter information such as interests, terms and conditions, identification information, sign terms and view information sent by the agent. The UI/UX interface may support multiple languages.

The UI/UX interface may have a voice recognition system. All commands that can be done using the UI/UX module can also be performed by voice. The user may have a microphone and a speaker to capture the voice and communicate information by voice to users. In addition, the voice recognition system may translate the user/business language into text by computers or vice versa.

In addition, there may be a remote-control system to provide the user remote control capabilities of the platform modules, to perform activities without having to use his own device. This may allow the user to protect his IP address, avoid getting cookies from businesses and exposing his location or other personal data. An example of the remote-control feature is the use of search or the view of the search result. The user can operate remotely the platform's browser and type the information he needs or click on the links he needs to view, using the IP address, identity of the agent/platform. The digital footprint could be traced backed to the platform, but not to the user. The UI/UX may support other capabilities, such as AI to help the agent perform more business transactions on behalf of the user.

Communications module: Allows connectivity to the marketplace, platform and user/business. Connectivity has multiple options, such as: Wi-Fi, wireless (4G/5G), Bluetooth, etc. The communications module may include NFC capabilities to perform payments using the digital wallet/token on the NFC supported POS systems. The communications module may provide a scan and read capability of products ID (Ex: QR code reader) to perform search information about them. In addition, the communications module can be used by users to show the temporary ID that is provided by the agent, to businesses with whom they are performing a transaction. On the other hand, it may be used by the business to scan/read and validate the temporary id.

The communications module may use security capabilities to ensure secure communication of the data and the business transactions within the agent and with other parties (platform, marketplace and user). When needed, the security system performs encryption of the data and the tunnel of communication used to transmit this critical data.

Storage module: A secure storage module may be used to store secure data at the edge/user device. An example of the data is the temporary key/ID that is provided to the user to receive products/service. The token of the payment card will be also stored.

API module: APIs may be used to execute all functions on the platform. In addition, the agent can access 3PP features (such as payment online) by API. On the other hand, SDKs can be used to allow applications developers to use the agent features by software. The platform may have API support capabilities to allow the agent to execute all features. It may include the following modules: storage system, browser module, search engine module, DLT/smart contract module, legal, user account management module, analytics/AI module, telecommunications module, notification module, and/or security module.

Storage system: Secure storage system to store user's data in a secure way.

Browser module: To perform search and ask transactions or others with the online open community

Search Engine module: To perform search and ask feature in the online private community.

DLT/Smart contract module: A Digital Ledger Technology may be used to store the data transactions history, important agreements and user accounts (for money and loyalty points) to provide transparency of uncontested data. In addition, the smart contract system may be used to automate the execution of users' terms and conditions and interests and other transactions (payment), to avoid any confusion and anyone tampering with the data.

Legal: A contract may be written, such as by lawyers, on behalf of the user to protect the user's data privacy legally. All businesses may need to sign it, to perform business transactions on the platform. This legal module will provide a legal mechanism to protect the user data privacy in addition to a technical automated execution of user's terms by the smart contract platform.

User Account Management Module: A user account may be created and managed by the platform for business transactions accounting. It may include at least these two parts: money and loyalty points. Debit/credit actions may be executed by smart contracts when the agent performs a payment/credit transaction or loyalty point transaction on behalf of the user. For example, the user account will be debited the amount of money that the agent pays on behalf of the user. Before making payment, the agent validates if the user account has enough funds prior to executing the payment transaction. The user main payment card may be used to fund the user account at the opening of the account or when there are not enough funds to execute transactions. In addition, loyalty points may be transferred to user's main loyalty card.

Analytic/AI module: Is used for different types of activities. Analytics and AI may be used to match users' interest with the business offer, to analyze and identify the type of business (Trusted, Non-Trusted or Semi-Trusted) and to analyze search results to identify the true/real ones, in addition to other reasons.

Telecommunication module: Allows connectivity to the marketplace, agent and user/business. Connectivity has multiple options: wireless (4G/5G), dedicated link, etc.

Notification Module: is used to notify user and business about results of business transactions. The notification system may be activated based on the user's/business' terms and conditions, programed in the smart contract. Emails, SMS and other communication tools may be used to communicate information about the business transactions to users. For example, in the case where the user would like to receive the search results by email, the platform will provide the search results by email.

Security Module: is used to secure the access to the agent/platform and data and the transactions that occur. The security module will include an identity and access management system to ensure that access to the platform, agent and marketplace is done by authorized users in a secure way. Users can access only what is permitted for their role. In addition, it may include encryption, VPN and other security features.

The marketplace may have some or all of the following three components: an online trusted community, an online open community, and/or an offline store.

### Online Trusted Community:

The platform may be connected to a private online community where users and businesses, members who sign terms and conditions legal/smart contract can perform business transactions without exposing their identity and data. All transactions may be controlled end to end by the platform. Users may have a unique ID per transaction to identify them in the community. In addition, the agent may perform transactions on their behalf to ensure that no personal data is shared.

In addition, this platform uses 3 axes to protect user's data privacy:

1—Legal: All businesses in the community signed a legal contract that forces them to protect users' data privacy. This contract is written to protect the user and not only the business
2—Smart contracts (Technical): User's terms and conditions and interest are translated into smart contracts that will be executed automatically prior to a business transaction on user's data, to ensure that the business complies with his data.
3—Transparency on user's data transactions. A DLT system provides users transparency on uncontested data transaction history.

### Online Open Community

The platform is connected to the online open community that is not controlled by the platform; however, the agent will perform transactions on behalf of the user, hence the user's identity is not disclosed, neither his data. In addition, Smart contracts and transparency are used to protect data privacy.

### Offline Store

The platform is also connected to the offline store, through the agent and the network. The business owner of the store can extend its presence to the online trusted community by registering.

In addition, Smart contracts and transparency are used to protect data privacy.

Features/Capabilities: The agent offers a menu of business transactions' options to use with a good customer experience design. The user/business can select the following options. Each feature can be used from 2 angles (user and business): 1) register on the agent and/or 2) search and ask a question/product/service:

Register on the agent: The user or business can use the agent UI/UX to input their information. The agent uses the security module to encrypt this information then sends it to the platform through APIs. The user's information could be but not limited to the following: contact information, financial to pay back or get credited for all the services the user uses or offers, consent, terms and conditions for data usage: generic terms or customized, and/or interest: static or dynamic.

The agent instructs the platform what to do with the data, based on the type. For example, the contact information is stored in the secure storage. The financial payment card will be used to open an account on the platform. Consent, terms and interest can be used to create/execute smart contract on the platform and critical information and data transactions history will be stored on the DLT.

Search and ask a question/product/service: The user can specify in the agent interface (i.e. UI/UX/API) his interest in topics of search, the source of information or the ones he is not interested in, where to do the search (online trusted community or online open community or in store (brick and mortar)), if once (now or later), during a period of time, etc.

This information is sent to the platform through APIs. The platform registers this information on the DLT, including time received by user. In addition, the platform may create smart contracts with the user's interest and conditions (such as where to do the search) that will be executed accordingly.

If specified by the user, the platform can use the analytics/AI module to analyse where to do the search (online trusted community, open community, others), what content providers to use to provide the most accurate information to the user, unlike other search engines that provides answers based on which companies pay more or for other reasons. The analytics AI module could use data models that would determine the accuracy of information and businesses/authors that are providing the information.

### Search in the Online Trusted Community

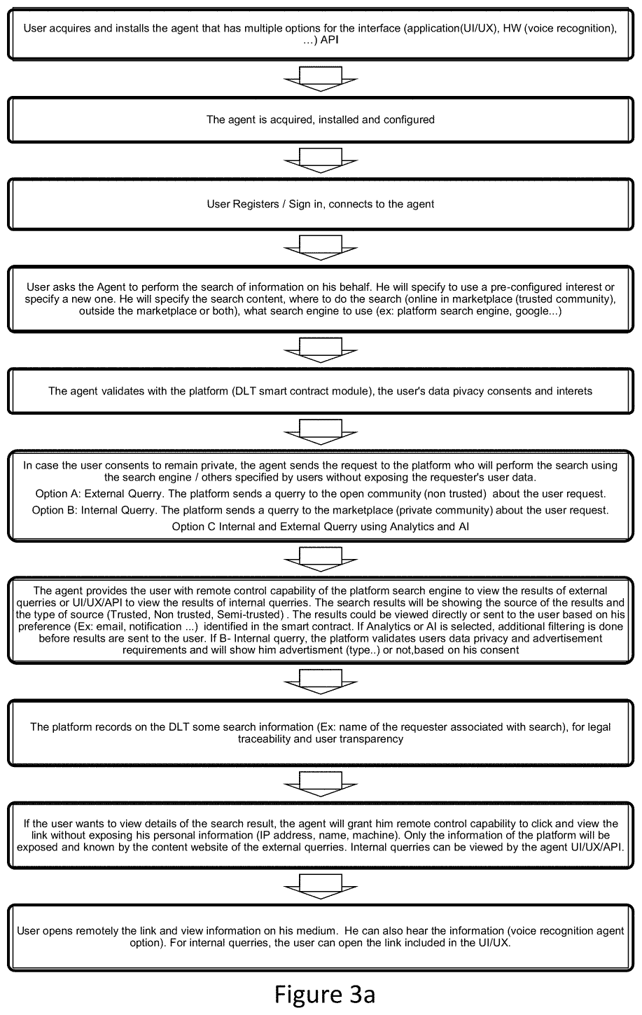

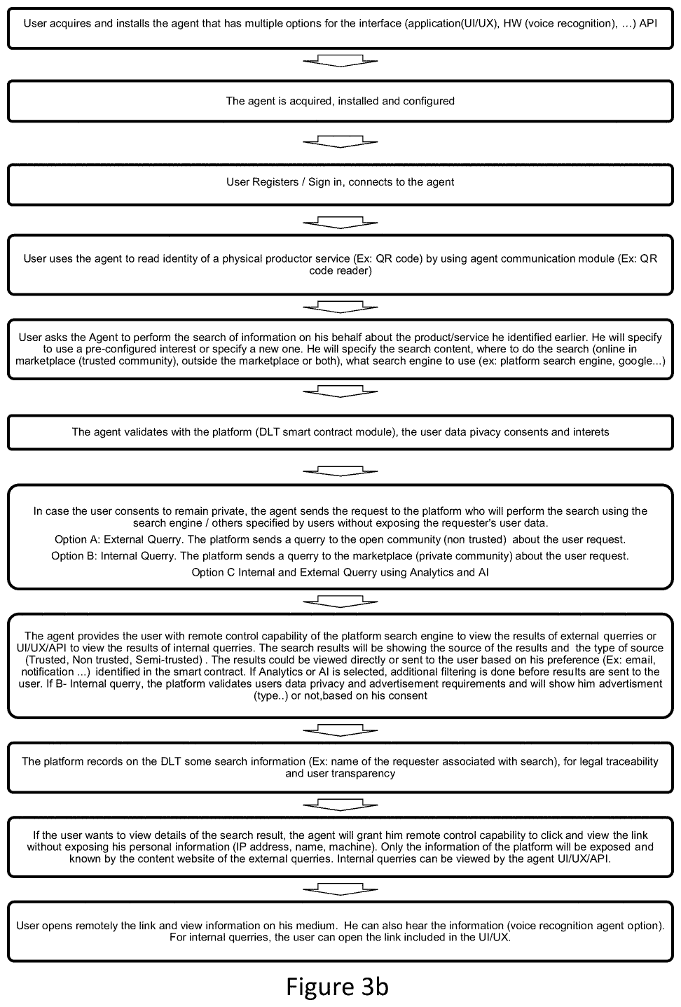

FIG. 3a is a flow diagram of a method for searching and asking questions online in an anonymous way without exposing the identity of the user according to some embodiments of the present technology. The user uses the agent UI/UX to access the search engine by API. The platform assigns a temporary user ID to the user to identify him during this transaction and to keep his identity hidden from the business. The user types his search topic in the search engine. The platform executes the user's interest and conditions smart contract. The platform might notify only the businesses who meet the user's criteria stated in these contracts, about the search subject and the user ID, through the agent's UI/UX or API.

The businesses provide the answer to the platform through the agent API. The platform uses a mechanism to validate that the answer does not include any advertising or cookies that can take the user's data. The platform validates on the DLT if the business and/or source of information signed the legal contract for user data privacy. If the business signed the legal contract, and because this transaction is occurring in the online private community, the platform will identify the business as trusted.

The platform executes the user's terms and conditions smart contract to validate the conditions of how he would like to be notified about the search results and will send the notification to the user in compliance with those terms. The platform notifies the user about the search result through the agent UI/UX/API based on his interest (when to be notified, how, where, etc.). The user may view the search result on the agent UI/UX. The result may include the list of businesses' answers with a logo identifying the type (such as trusted, not trusted and semi-trusted). The user can then click on any of the links to view the corresponding result in detail. The transaction history (search subject, user ID, etc.) may be saved on the DLT for legal purposes.

### Search in the Online Open Community:

The user may use the agent UI/UX and/or remote control capability to access the platform browser. The platform assigns a temporary user ID to the user to identify him during this transaction. The user types his search web site and search topic in the web browser.

The platform registers the details of the transaction on the DLT and executes the user's interest and conditions smart contract. The platform will send the search in the open community, if the user requests it. The business will get the ip address of the user/platform, but not the user. The businesses may then provide the answers to the browser.

The platform may execute the smart contract of the user's wanted list of businesses. If a business provided results to the web browser and it is blacklisted by the user, the platform may eliminate that result from the web browser.

The platform validates on the DLT if the business and/or source of information signed the legal contract for user data privacy. If the business did not sign the legal contract, and because this transaction is occurring in the online open community, the platform will identify the business as non-trusted.

The platform executes the user's terms and conditions smart contract to validate the conditions of how he would like to be notified about the search results and will send the notification to the user in compliance with his terms. The platform notifies the user about the search result through the agent UI/UX/API based on his interest (when to be notified, how, where, etc.).

The user will view the search result on the platform browser using the agent's UI/UX remote control capability. The result will include the list of businesses' answers with a logo identifying the type (such as trusted, not trusted and semi-trusted).

The user may use the remote-control capability to click on the link to view the result in detail. The business can identify the platform but not the user. The history of the view transaction is stored on the DLT

### Search and Ask Instore

FIG. 3b is a flow diagram of a method for searching and asking questions instore in an anonymous way without exposing the identity of the user according to some embodiments of the present technology. The user may use the agent's communication module to scan the ID of the product that he is interested in learning about. The user may use the agent interface UI/UX/API to perform a search and ask about this product. The architecture will be the same for a) search in the online trusted community and b) search in the online open community.

### Advertise and Market

The user can specify in the agent interface (i.e. UI/UX/API) his interest in the types, brands, specification and other information of the products/services, that he is interested in. The user may also have specified his data privacy terms and conditions and the terms on how to communicate the results with him. This information may be sent to the platform through APIs. The platform registers this information on the DLT, including time received by user. In addition, the platform may create smart contracts with the user's interests and conditions that will be executed accordingly.

The user can specify from where he would like to receive advertising: from the online trusted community, from the online non trusted (open) or other (TOT, ambient devices) community. If specified by the user, the platform can use the analytics/AI module to use multiple sources of advertising and marketing based on user's criteria. Analytics and AI may use smart contract conditions as input to provide results.

### Advertise and Market in the Online Trusted Community

The platform may assign a temporary user ID to the user to identify him during this transaction and to keep his identity hidden from the business. Two methods may be used for advertising and marketing: Business initiates advertising and/or platform initiates interests.

### Business Initiates Advertising—Offer:

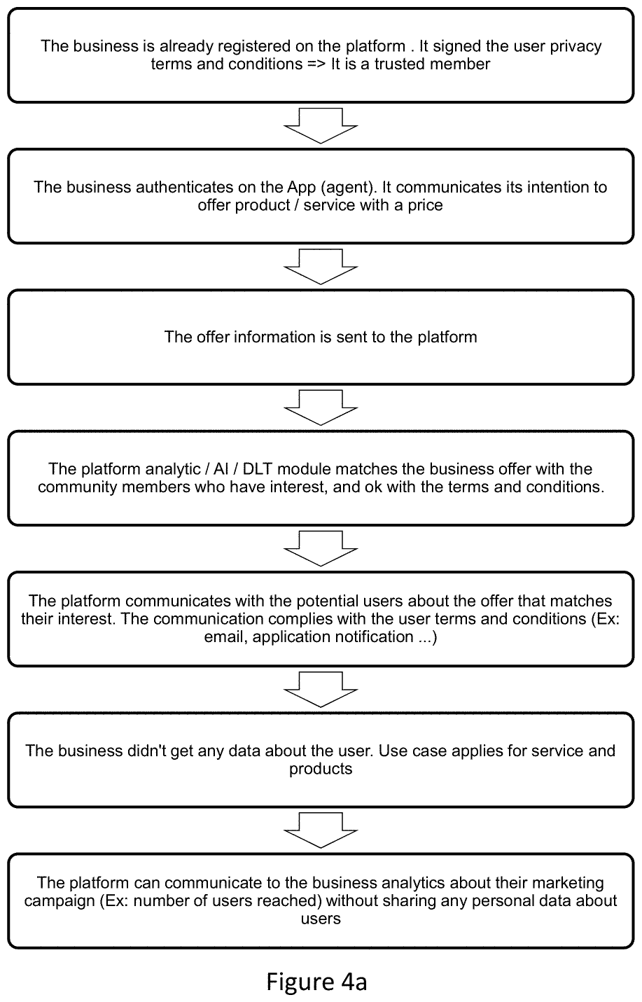

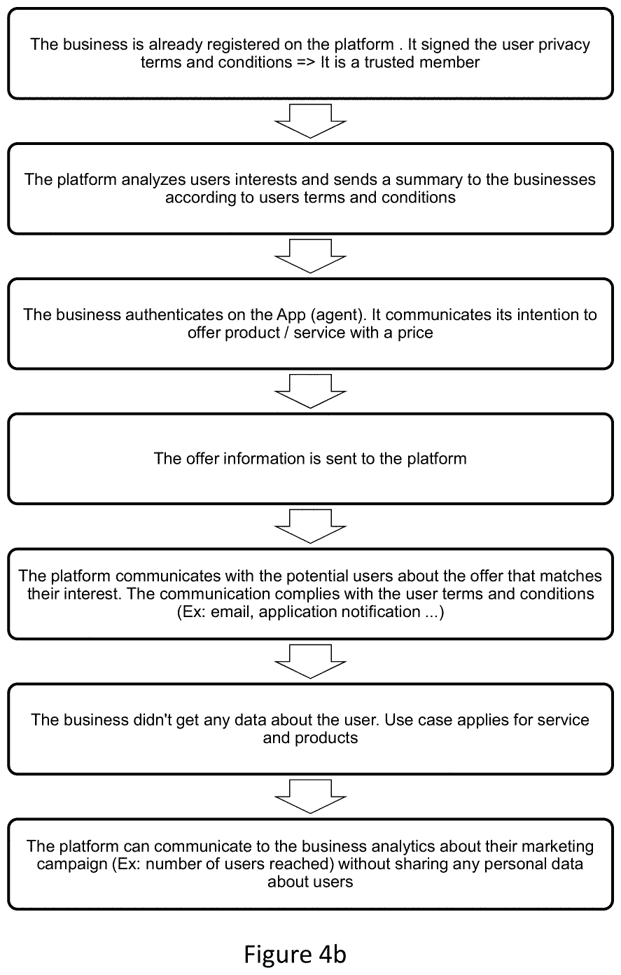

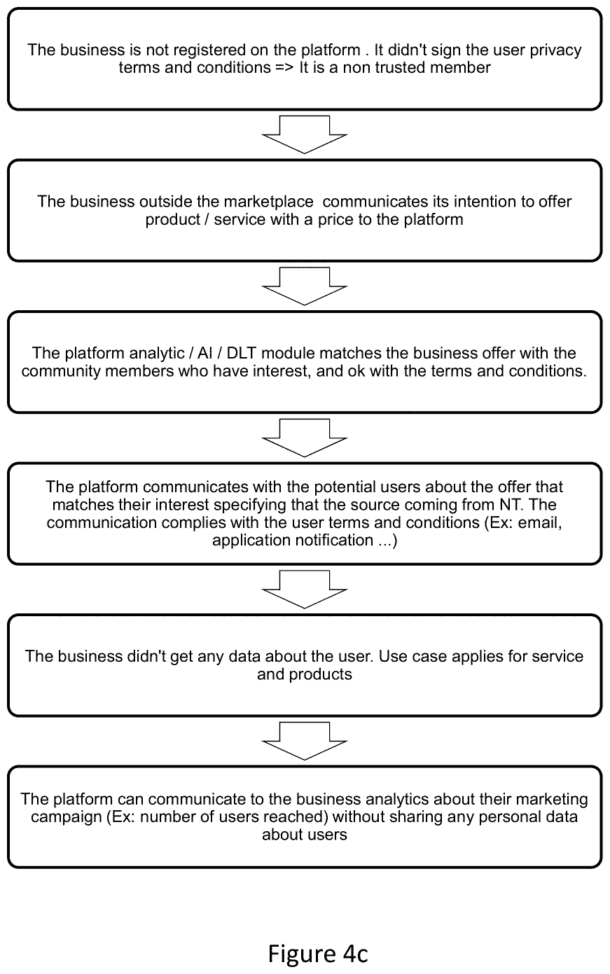

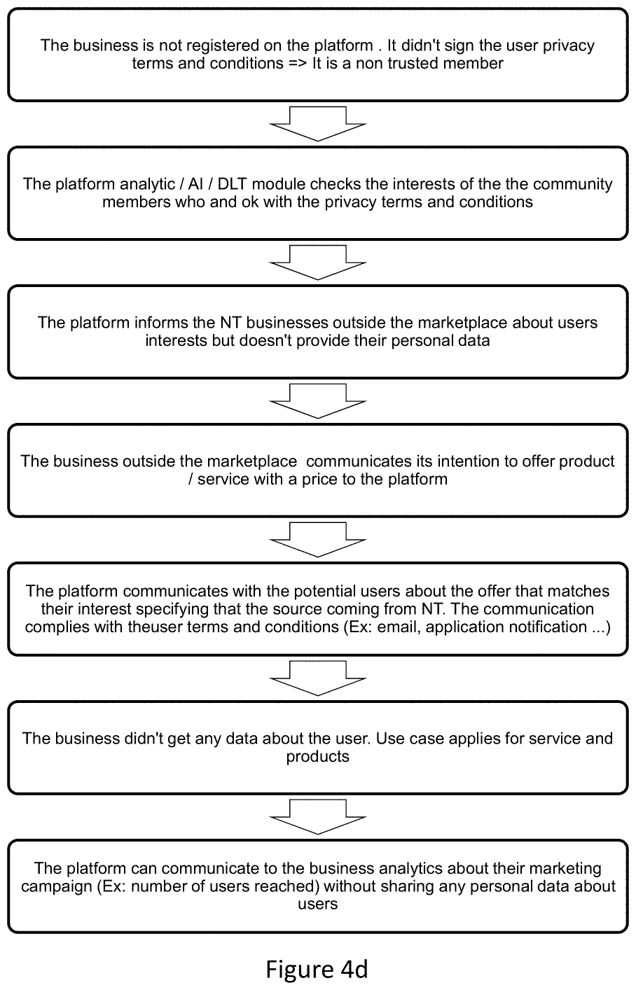

FIG. 4a is a flow diagram of a method for a business initiating advertising according to some embodiments of the present technology. Businesses may use the agent interface (i.e. UI/UX/API) to specify the product/service that they would like to advertise and promote with the offer terms and conditions (price, period, etc.) and their user and data privacy conditions. This information is sent by API to the platform that will store the data in the secure data storage, specific data in the DLT. In addition, smart contracts will be created based the business terms and conditions.

The format of the advertising template is done by the platform and does not include any cookies or other mechanism that can identify the user or push unwanted notifications/advertising to the user. The template of the advertising is filled by the business information by UI/UX or API. The platform executes the business advertising smart contracts. This will use APIs to initiate analytics/AI modules that will execute users' smart contracts to analyse users' interest and matches them with the businesses' advertising.

For the users who's interest matches with the business advertising, the platform executes the user's terms and conditions smart contract to validate the conditions of how he would like to be notified about the advertising results and will send them the notification using the agent interface (UI/UX/API, etc.) about the advertising and marketing offer accordingly. The user can confirm his interest using the same API. This information is saved on the DLT.

In addition, the platform validates on the DLT if the business and/or source of information signed the legal contract for user data privacy. If the business signed the legal contract and since this transaction is occurring in the online private community, the platform will identify the business as Trusted and will show that to the user (such as via a logo).

On the other hand, the platform may execute the business' terms and conditions smart contract to validate the conditions of how he would like to be notified about the advertising results and will send them the notification about the user's ID that are interested in their advertising. Notifications are sent via the agent interface (i.e. UI/UX/API). The business might not be able to identify the user as this ID is unique per transaction, per user.

The user will view the advertising result on the agent interface (i.e. UI/UX/API). The result will include the list of businesses answers with a logo identifying the type (such as trusted, not trusted and semi-trusted). The user can click on any of the links to view the advertising in detail without exposing his ID or getting cookies that could gather personal information on him or push unwanted advertising to him. The transaction history (search subject, user ID . . . ) may be saved on the DLT for auditing/legal purposes.

### Platform Initiates Interests—Demand:

FIG. 4b is a flow diagram of a method for platform initiated advertising according to some embodiments of the present technology. The platform may execute the user's interests and data privacy terms and conditions. This will use APIs to initiate analytics/AI module that will execute users' smart contracts to analyse users' interest. Users' interests are classified and recorded in a secure storage. The platform executes the businesses' terms and conditions smart contract to validate the conditions of how they would like to be notified about users' demands (interest) advertising results and will send them results using the agent interface (UI/UX/API, etc.) in compliance with their conditions. Only the number of users' interest is sent without any information about users.

Businesses may use the agent interface (i.e. UI/UX/API) to specify the product/service that they would like to advertise and promote with the offer terms and conditions (price, period, etc.) and their user and data privacy conditions. This information may be sent by API to the platform that will store the data in the secure data storage, specific data in the DLT. In addition, smart contracts may be created based the business terms and conditions.

The format of the advertising template is done by the platform that doesn't include any cookies or other mechanism that can identify the user or push unwanted notifications/advertising to the user. The template of the advertising is filled by the business information by UI/UX or API.

In addition, the platform validates on the DLT if the business, source of information signed the legal contract for user data privacy. If the business signed the legal contract and since this transaction is occurring in the online private community, the platform will identify the business as trusted and will show that to the user (logo).

On the other hand, the platform executes the users' terms and conditions smart contract to validate the conditions of how he would like to be notified about the advertising results and will send them the notification about the businesses offer advertising. Notifications are sent via the agent interface (i.e. UI/UX/API).

The user will view the advertising result on the agent interface (UI/UX/API). The result will include the list of businesses answers with a logo identifying the type (such as trusted, not trusted and semi-trusted). The user can click on any of the links to view the advertising in detail without exposing his ID or getting cookies that could gather personal information on him or push unwanted advertising to him. The transaction history (search subject, user ID, etc.) may be saved on the DLT for auditing/legal purposes.

The platform can use the analytics/AI module to analyze the marketing campaign for the business (number of users reached, number of users interested, etc.) and will communicate this business intelligence information with businesses without sharing any personal data on the users.

### Advertise and Market in the Online Non-Trusted (Open) Community

The platform may assign a temporary user ID to the user to identify him during this transaction and to keep his identity hidden from the business. Two methods may be used for advertising and marketing: business initiates advertising and/or platform initiates interests.

### Business Initiates Advertising—Offer:

FIG. 4c is a flow diagram of a method for business initiated advertising in an open community according to some embodiments of the present technology. Business may use the agent interface (UI/UX/API) or another medium to specify the product/service that they would like to advertise and promote with the offer terms and conditions (price, period, etc.). This information may be sent by API to the platform that will store the data in the secure data storage, specific data in the DLT. The platform may use APIs to initiate analytics/AI modules that will execute users' smart contracts to analyse users' interest and match them with the business advertising.

For the users who's interest matches with the business advertising, the platform executes the users' terms and conditions smart contract to validate the conditions of how he would like to be notified about the advertising results and will send them the notification using the agent interface (UI/UX/API) about the advertising and marketing offer accordingly.

In addition, the platform validates on the DLT if the business and/or source of information signed the legal contract for user data privacy. If the business did not sign the legal contract and since this transaction is occurring in the online non-trusted community, the platform will identify the business as non-trusted and will show that corresponding logo to the user. The user may confirm whether or not they are interested in this advertising.

The platform will send the business notification about the user's ID that is interested in their advertising. Notifications are sent via the agent interface (UI/UX/API) or other mediums/interfaces. The business might not be able to identify the user as this ID is unique per transaction, per user.

The user may view the advertising results on the agent interface (UI/UX/API). The result will include the list of businesses advertising with a logo identifying the type (such as trusted or not trusted). The user can use the remote control module of the platform using the agent API to click on any of the links to view the advertising in detail without exposing his ID or getting cookies that could gather personal information on him or push unwanted advertising to him. The platform may be exposed to the businesses, but not the user. The transaction history (search subject, user ID, etc.) may be saved on the DLT for auditing/legal purposes.

### Platform Initiates Interests—Demand:

FIG. 4d is a flow diagram of a method for platform initiated interest in an open community according to some embodiments of the present technology. The platform executes the user's interests and data privacy terms and conditions. The platform may use APIs to initiate the analytics/AI module that will execute users' smart contracts to analyse users' interest. Users' interests may be classified and recorded in a secure storage. The platform may send the online non-trusted (open) community by the agent interface (UI/UX/API) and/or other mediums/interfaces users' demands (interest).

Only the number of users' interest is sent without any information about users. Only the users who are interested and who specified that they would like to receive advertising from the non-trusted community will be concerned.

Businesses may use the agent interface (UI/UX/API) or other mediums/interfaces to specify the product/service that they would like to advertise and promote with the offer terms and conditions (price, period, etc.). This information may be sent by API to the platform that will store the data in the secure data storage, specific data in the DLT.

In addition, the platform validates on the DLT if the business, source of information signed the legal contract for user data privacy. If the business did not sign the legal contract and since this transaction is occurring in the online non trusted (open) community, the platform will identify the business as non-trusted and will show that to the user (such as via the logo).

On the other hand, the platform executes the users' terms and conditions smart contract to validate the conditions of how he would like to be notified about the advertising results and will send them the notification about the businesses offer advertising. Notifications are sent via the agent interface (UI/UX/API).

The user may view the advertising result on the agent interface (UI/UX/API). The result will include the list of businesses answers with a logo identifying the type (such as trusted, not trusted, etc.). The user can use the remote-control module of the platform using the agent API to click on the link to view the advertising in detail without exposing his ID or getting cookies that could gather personal information on him or push unwanted advertising to him. The platform may be exposed, but not the user. The transaction history (search subject, user ID, etc.) is saved on the DLT for auditing/legal purposes.

The platform can use the analytics/AI module to analyze the marketing campaign for the business (number of users reached, number of users interested, etc.) and will communicate this business intelligence information with businesses without sharing any personal data on the users.

### Buying and Selling

### Agreement to Buy and Sell in the Online Trusted Community:

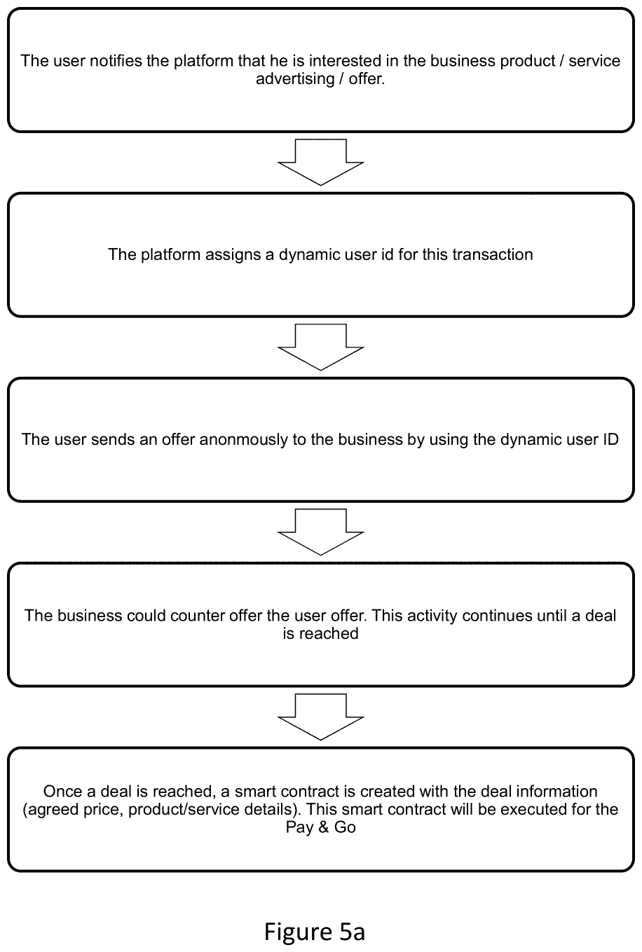

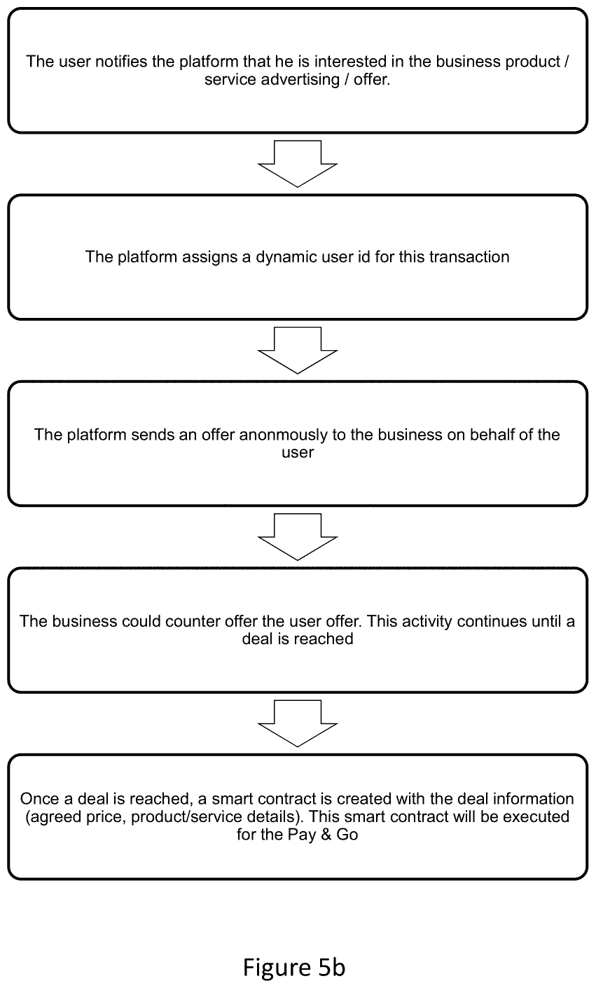

FIG. 5a is a flow diagram of a method for buying and selling online in a trusted community according to some embodiments of the present technology. The user may notify the agent via the interface (UI/UX/API) his interest in the business advertising/marketing and his offer (price, terms, etc.). This information may be sent by API to the platform that will store the data in the secure data storage, specific data in the DLT. In addition, smart contracts may be created based the user offer terms and conditions. The platform may assign a temporary user ID to the user to identify him during this transaction and to keep his identity hidden from the business.

The platform executes the business' terms and conditions smart contract to validate the conditions of how they would like to be notified about the user's offer and will send them the notification about the user's ID and his offer. Notifications are sent via the agent interface (UI/UX/API).

The business might not be able to identify the user as this ID is unique per transaction, per user. The business will view the user's offer on the agent interface (UI/UX/API). The business notifies the agent via the interface (UI/UX/API) his interest in selling, and he may accept the offer and/or propose a counter-offer (price, terms, etc.). This information may be sent by API to the platform that will store the data in the secure data storage, specific data in the DLT. In addition, smart contracts will be created based on the counter-offer terms and conditions.

Once both the user and the business agree on the conditions of the sale transaction, the information will be sent by API to the platform that will store the data in the secure data storage, specific data in the DLT. In addition, smart contracts will be created based on the sale agreement terms and conditions and it will be executed. The transaction history (offer, counteroffer, sale, user ID, etc.) may be saved on the DLT for auditing/legal purposes.

### Agreement to Buy and Sell in the Online Non-Trusted (Open) Community

FIG. 5b is a flow diagram of a method for buying and selling online in an open and non-trusted community according to some embodiments of the present technology. The user notifies the agent via the interface (UI/UX/API) his interest in the business advertising/marketing and his offer (price, terms, etc.). The information may be sent by API to the platform that will store the data in the secure data storage, specific data in the DLT. In addition, smart contracts may be created based the user offer terms and conditions. The platform may assign a temporary user ID to the user to identify him during this transaction and to keep his identity hidden from the business.

The platform may send the business the notification about the user's ID and his offer. Notifications are sent via the agent interface (UI/UX/API) or another medium/interface. The business might not be able to identify the user as this ID is unique per transaction, per user.

The business may view the user's offer on the agent interface (UI/UX/API) or another medium/interface. The business may notify the agent via the interface (UI/UX/API) his interest in selling, and/or he may propose a counter-offer (price, terms, etc.). This information is sent by API to the platform that will store the data in the secure data storage, specific data in the DLT. In addition, smart contracts will be created based on the counter-offer terms and conditions.

Once both the user and the business agree on the conditions of the sale transaction, the information will be sent by API to the platform that will store the data in the secure data storage, specific data in the DLT. In addition, smart contracts will be created based on the sale agreement terms and conditions and they may be executed. The transaction history (offer, counter-offer, sale, user ID, etc.) is saved on the DLT for auditing/legal purposes.

### Pay and Go

### Registration to the Pay and go Application

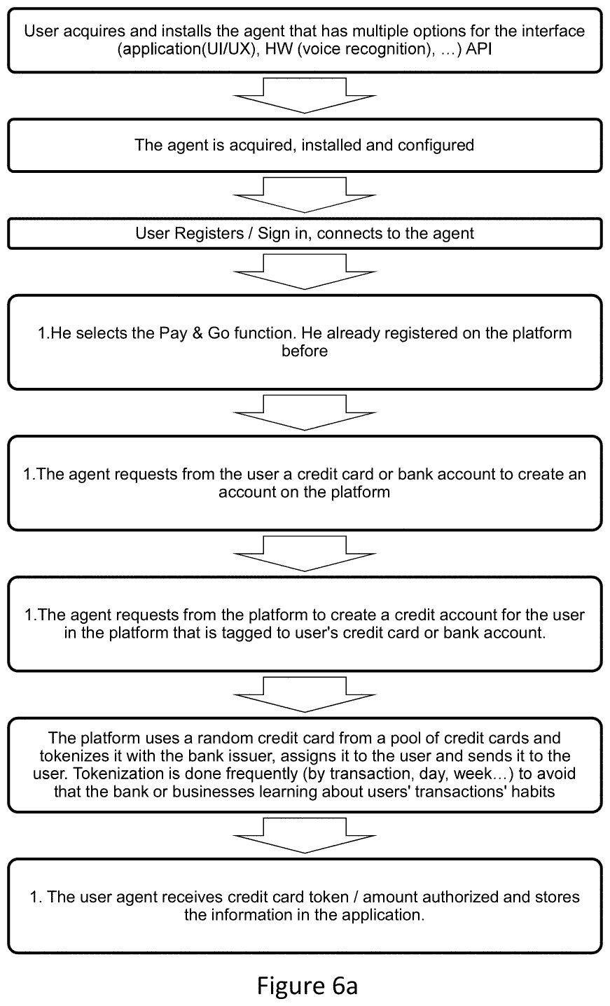

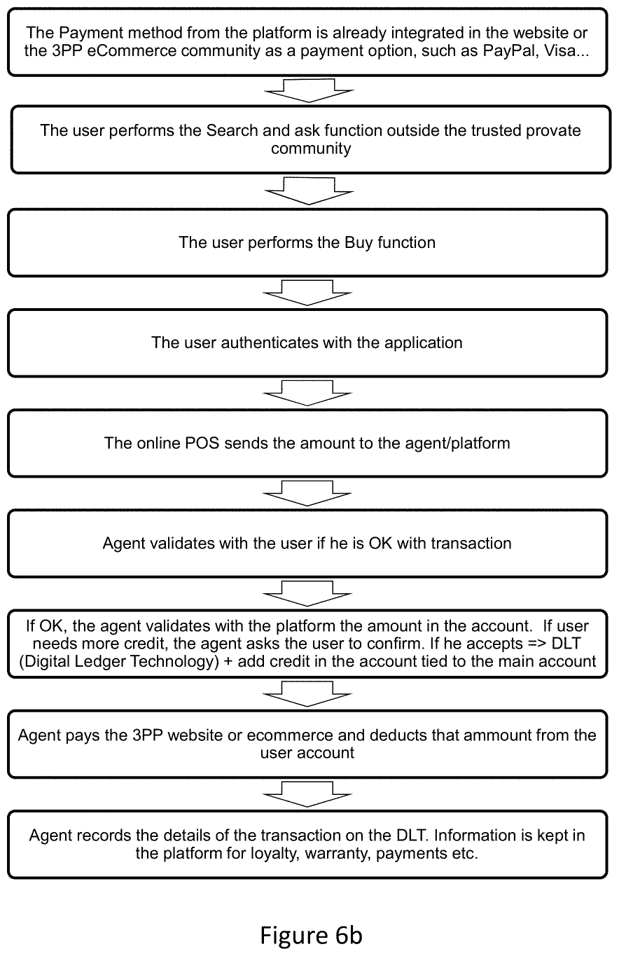

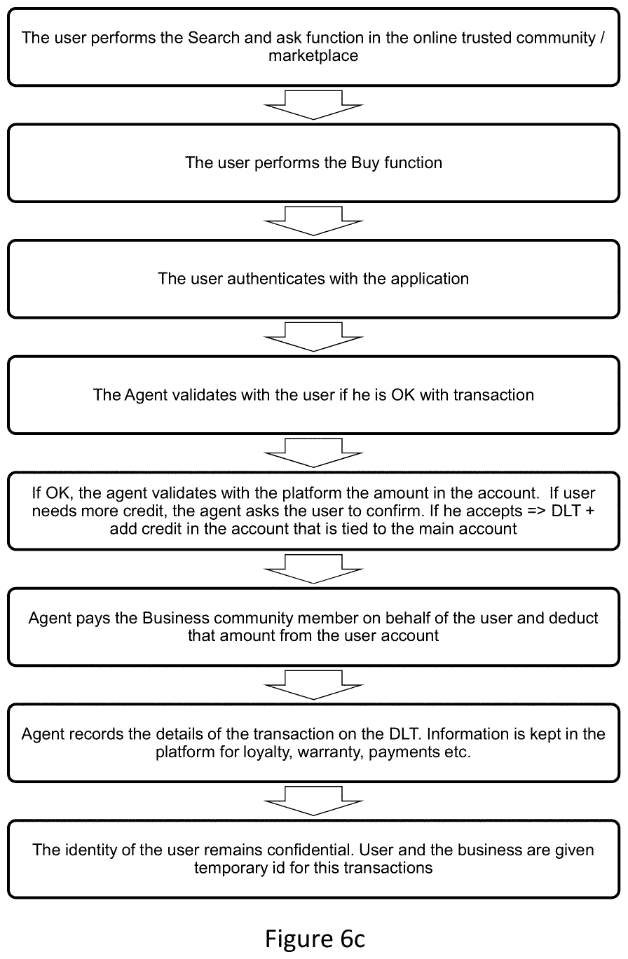

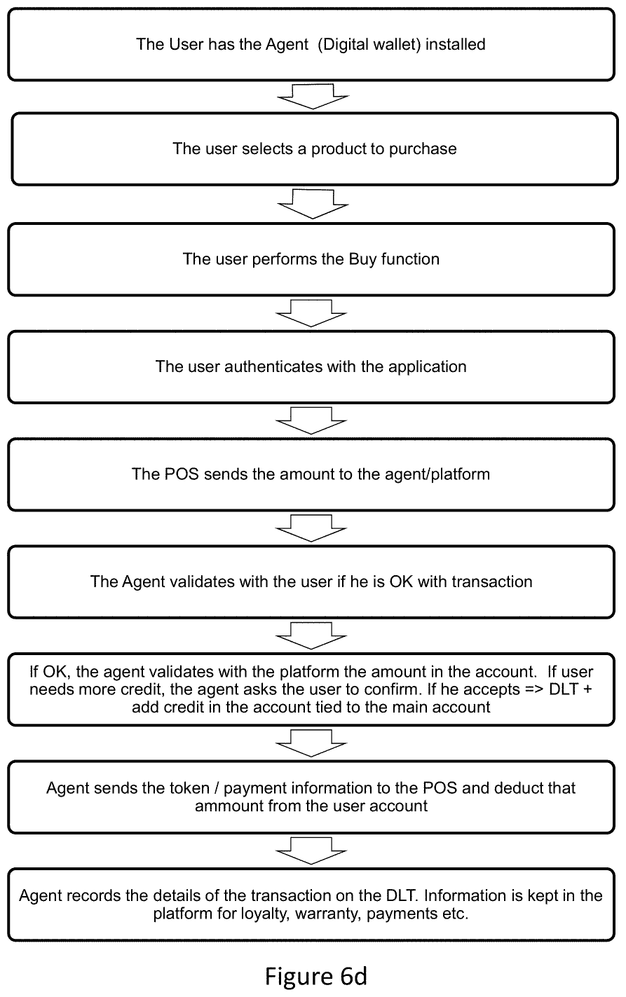

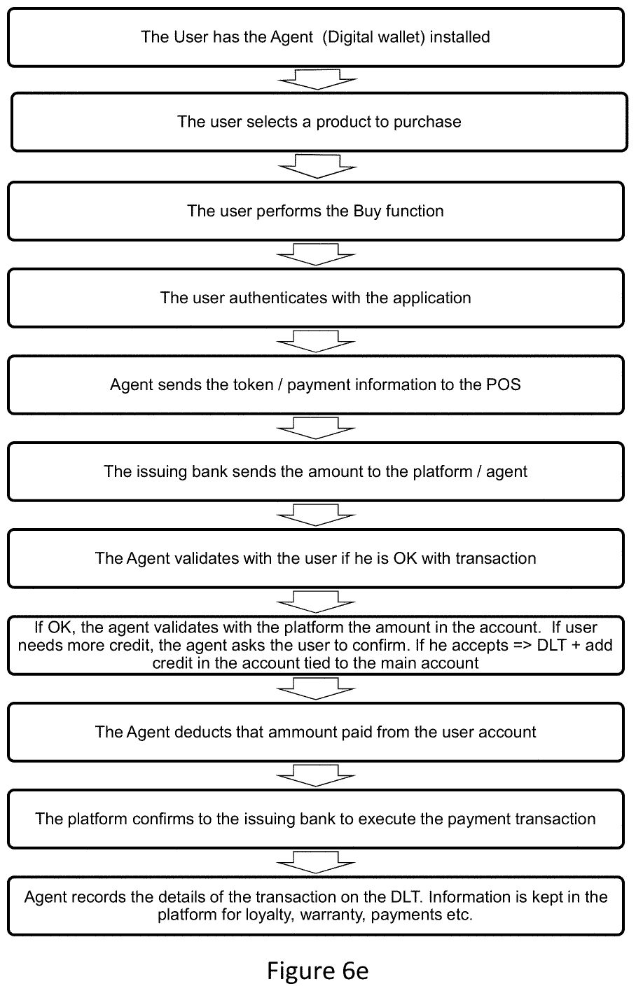

FIG. 6a is a flow diagram of a method for registration on a pay and go application according to some embodiments of the present technology. The user registers to the pay and go then authenticates to the application. The agent may request from the user information about his original payment card (visa, debit, etc.) using the interface (UI/UX/API). This information may only be used for the platform financial transactions. The user inputs his information. The agent encrypts this data and sends it by API to the platform.

The platform validates the payment card with the issuing financial institution and creates the user account. The payment card information is stored in the secure storage system. Transaction information is stored on the DLT. The agent may request, from the user, the credit amount that he would like to start with, using the interface (UI/UX/API). This information is only for the platform financial transactions.

The user may input the amount. The agent encrypts this data and sends it by API to the platform. The platform may access the secure storage to use the credit card to process a payment from the user credit card to the platform with the amount specified by the user. Payment is performed with the issuing financial institution. The platform updates the user account with the amount. The amount and other details about the transaction are stores on the DLT and a confirmation is sent to the user in compliance with his notification conditions.

The platform may use a payment cards assignment module that utilises an algorithm to assign a card for the pay and go transaction, from a pool of payment cards that belong to the platform. This assignment is done at a frequency that ensures that businesses do not guess the user's ID and purchases to protect user's personal data. Once the card is assigned to the user, the platform requests a token from the issuing bank. This token is then sent to the agent by API. The agent will store it in the user's application (digital wallet) for the next purchase. Information about the token number, transaction, and/or owner will be stored in the DLT. This process may be repeated each time the platform assigns a new card to the user to ensure that no business can guess/correlate users' purchases.

Pay and go in the Online not-Trusted (Open) Marketplace

FIG. 6b is a flow diagram of a method for a transaction in an open community on the pay and go application according to some embodiments of the present technology. The payment method using this platform is integrated as an option “Pay with” in the 3PP website or ecommerce site, like PayPal, Visa, Amex, etc. When the user executes the buy activity, the agent confirms the purchase to the online business. The online business' POS system sends the details of the transaction and the amount to the agent by API.

The agent sends the transaction information (name of business, transaction amount, product, etc.) to the user to confirm it. The agent sends the transaction information and the user confirmation to the platform by API. The platform records the information in the secure storage and some specific information on the DLT. The platform issues a smart contract that will guide the API to validate if the user account has enough funds and to block that account for this transaction.

If the user does not have enough credit in his account for the payment of this transaction, the platform sends to the agent the amount that is needed. The agent requests from the user to confirm the amount that needs to transfer from his personal payment card to the platform user account to cover the cost of this transaction. The user confirms to the agent who will send this confirmation to the platform. The platform will store the confirmation on the DLT and will create a smart contract that will process the payment as per the user's confirmation.

Payment is performed with the issuing financial institution. The platform updates the user account with the amount. The amount and other details about the transaction are stored on the DLT and a confirmation is sent to the user in compliance with his notification conditions.

The smart contract will request that the agent perform payment with the business using their API. The business confirms the payment to the agent who will send that confirmation to the platform. The platform records the confirmation in the secure storage and updates the DLT with the transaction status. The smart contract deducts the amount from the user account and credits the platform account and updates the DLT. The platform sends the final confirmation about the transaction to the agent who will provide that information to the user. The platform updates the DLT with the status.

### Pay & go in the Online Trusted Marketplace

FIG. 6c is a flow diagram of a method for a transaction in an online trusted community on the pay and go application according to some embodiments of the present technology. When the user executes the buy activity, the agent confirms the purchase to the business. A smart contract is created with the buy and sell agreement (merchandise, cost, etc.). The agent sends the transaction information (name of business, transaction amount, product, etc.) to the user to confirm it. The agent sends the transaction information and the user confirmation to the platform by API. The platform records the information in the secure storage and some specific information on the DLT.

The platform issues a smart contract that will guide the API to validate if the user account has enough funds and to block that account for this transaction. If the user does not have enough credit in his account for the payment of this transaction, the platform sends, to the agent, the amount missing. The agent requests that the user confirm the amount that is needed to transfer from his personal payment card to the platform user account to cover the cost of this transaction. The user may confirm the transfer to the agent, and the agent may send this confirmation to the platform. The platform will store the confirmation on the DLT and will create a smart contract that will process the payment as per the user's confirmation.

Payment may be performed with the issuing financial institution. The platform updates the user account with the amount. The amount and other details about the transaction are stored on the DLT and a confirmation is sent to the user in compliance with his notification conditions. The smart contract deducts the amount from the user account and credits the business account on the platform and updates the DLT. The platform records the confirmation in the secure storage and updates the DLT with the transaction status. The platform sends the final confirmation about the transaction to the agent who will provide that information to the user and the business. The platform updates the DLT with the status.

Pay and go in-Store Transaction

FIG. 6d is a flow diagram of a method for a transaction in a store on the pay and go application in which the point of sale (POS) device sends the transaction details according to some embodiments of the present technology. The POS device may send the transaction details and then wait for approval prior to executing a payment transaction. When the user executes the buy activity in the store, the business' POS system sends the details of the transaction and the amount and waits for the confirmation from the agent before executing the payment transaction with the bank.

The agent may send the transaction information (name of business, transaction amount, product, etc.) to the user to confirm the transaction. The agent may send the transaction information and the user confirmation to the platform by API. The platform records the information in the secure storage and some specific information on the DLT.

The platform may issue a smart contract that will guide the API to validate if the user account has enough funds and to block that account for this transaction. If the user does not have enough credit in his account for the payment of this transaction, the platform sends, to the agent, the amount missing. The agent requests that the user confirm the amount that will be transferred from his personal payment card to the platform user account to cover the cost of this transaction. The user confirms to the agent who will send this confirmation to the platform. The platform will store the confirmation on the DLT and will create a smart contract that will process the payment as per the user's confirmation.

Payment is performed with the issuing financial institution. The platform updates the user account with the amount. The amount and other details about the transaction are stored on the DLT and a confirmation is sent to the user in compliance with his notification conditions. The smart contract may request that the agent perform payment with the business using the POS. The business POS system may perform the payment transaction with the issuing bank and confirm the payment to the agent who will send that confirmation to the platform. The platform records the confirmation in the secure storage and update the DLT with the transaction status.

The smart contract deducts the amount from the user account and credit the platform account and updates the DLT. The platform sends the final confirmation about the transaction to the agent who will provide that information to the user. The platform updates the DLT with the status.

FIG. 6e is a flow diagram of a method for a transaction in a store on the pay and go application in which the issuing bank sends the transaction details according to some embodiments of the present technology. The issuing bank may send the transaction details to the platform and request approval before executing the payment transaction. When the user executes the buy activity in the store, the business' POS performs the payment transaction using the agent token with the issuing bank.

Priori to confirming the transaction with the business POS system, the bank may send the details of the transaction and the amount by API and waits for the confirmation from the agent. The agent may send the transaction information (name of business, transaction amount, product, etc.) to the user to confirm it. The agent may send the transaction information and the user confirmation to the platform by API. The platform may record the information in the secure storage and some specific information on the DLT.

The platform issues a smart contract that will guide the API to validate if the user account has enough funds and to block that account for this transaction. If the user does not have enough credit in his account for the payment of this transaction, the platform sends, to the agent, the amount missing. The agent requests that the user confirm the amount that will be transferred from his personal payment card to the platform user account to cover the cost of this transaction. The user confirms the amount to the agent, and the agent sends this confirmation to the platform. The platform will store the confirmation on the DLT and will create a smart contract that will process the payment as per the user's confirmation.

Payment may be performed with the issuing financial institution. The platform updates the user account with the amount. The amount and other details about the transaction are stored on the DLT and a confirmation is sent to the user in compliance with his notification conditions.

The smart contract will request that the agent confirm payment with the issuing bank using the API. The issuing bank confirms the payment with the business POS and payment is done and confirms the payment to the agent who will send that confirmation to the platform. The platform records the confirmation in the secure storage and updates the DLT with the transaction status. The smart contract deducts the amount from the user account and credits the platform account and updates the DLT. The platform sends the final confirmation about the transaction to the agent who will provide that information to the user. The platform updates the DLT with the status.

### Loyalty Points System

### Registration to the Collect Loyalty Points System

The user may register to the collect loyalty points system and then authenticate to the application. The agent may request, from the user, information about his original loyalty card using the interface (UI/UX/API). This information is only for the platform loyalty points transactions. The user may input his information. The agent may encrypt this data and sends it by API to the platform. The platform creates the user account. The loyalty point card information is stored in the secure storage system. Transaction information are stored on the DLT.

The system may use a loyalty program mechanism that uses an algorithm to assign a card for loyalty transaction, from a pool of loyalty points' cards. This assignment may be done at a frequency that ensures that businesses don't guess the user's ID and purchases to protect user's personal data. Once the card is assigned to the user, the platform requests a token from the issuing loyalty business. This token is then sent to the agent by API. The agent will store it in the user's application (digital wallet) for the next loyalty point transaction. Information about the token number, transaction, and/or owner will be stored in the DLT. This process may be repeated every time the platform assigns a new card to the user to ensure that no business can guess/correlate users' purchases and loyalty point transactions.

### Collect Loyalty Points in the Online Non-Trusted (Open) Marketplace

The loyalty point method using this platform may be integrated as an option “collect loyalty point with” in the 3PP website or ecommerce site. When the user executes the Pay & Go activity and he requests to collect loyalty points, the online business' POS system sends the details of the transaction and the amount of the loyalty points to the agent by API. The agent sends the transaction information (name of business, loyalty point amount, product, etc.) to the user and to the platform by API. The platform records the information in the secure storage and some specific information on the DLT. The smart contract deducts the loyalty point amount from the platform and credit the user account and updates the DLT. The platform sends the final confirmation about the transaction to the agent who will provide that information to the user. The platform updates the DLT with the status.

### Collect Loyalty Points in the Online Trusted Marketplace

When the user executes the Pay & Go activity, the agent confirms the purchase to the business. A smart contract is created with the buy and sell agreement (merchandise, cost, loyalty point amount, etc.). The agent sends the transaction information (name of business, transaction loyalty point amount, product, etc.) to the user and the platform by API. The platform records the information in the secure storage and some specific information on the DLT. The smart contract deducts the loyalty points from the business account and credit the user account on the platform and updates the DLT. The platform records the confirmation in the secure storage and updates the DLT with the transaction status. The platform sends the final confirmation about the transaction to the agent who will provide that information to the user and the business. The platform updates the DLT with the status.

### Collect Loyalty Points in the Store

When the user executes the Pay & Go activity in the store and provides the loyalty card from the digital wallet to collect points, the business' POS system sends the details of the transaction and the amount of loyalty points to the agent. The agent sends the transaction information (name of business, transaction loyalty point amount, product, etc.) to the user and the platform by API. The platform records the information in the secure storage and some specific information on the DLT. The platform issues a smart contract that will deduct the amount from the platform account and credit the user account and updates the DLT. The platform sends the final confirmation about the transaction to the agent who will provide that information to the user. The platform updates the DLT with the status.

### Ship and Receive

The user performed the pay and go function for the product or service and informs the agent by interface UI/UX/API that he needs to receive the product/service in an anonymous way, without jeopardizing his ID or his address/personal data. The business could also request from the agent by interface (UT/IA/API) to ship the product/service in a private way.

### Ship and Receive in the Online Trusted Market

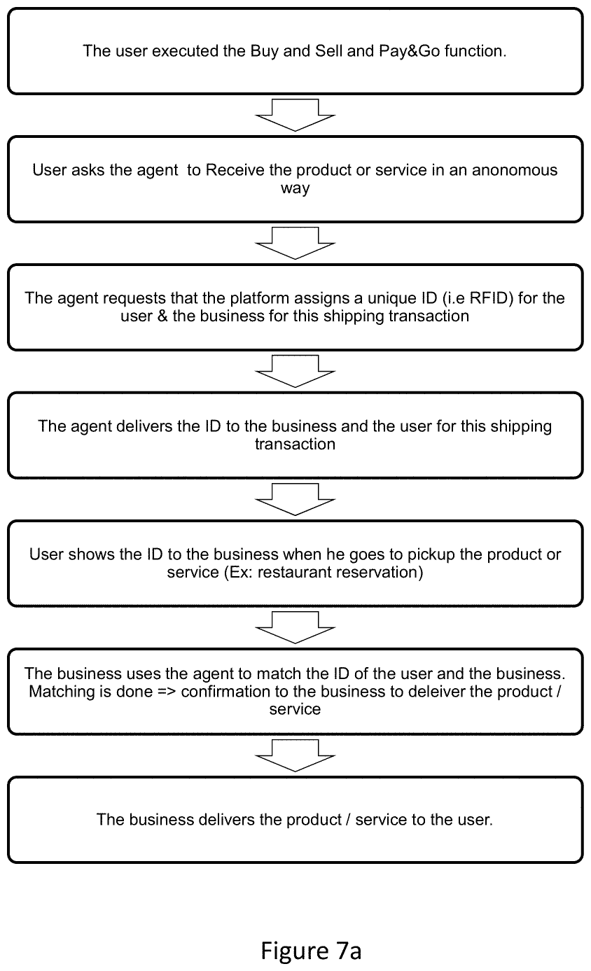

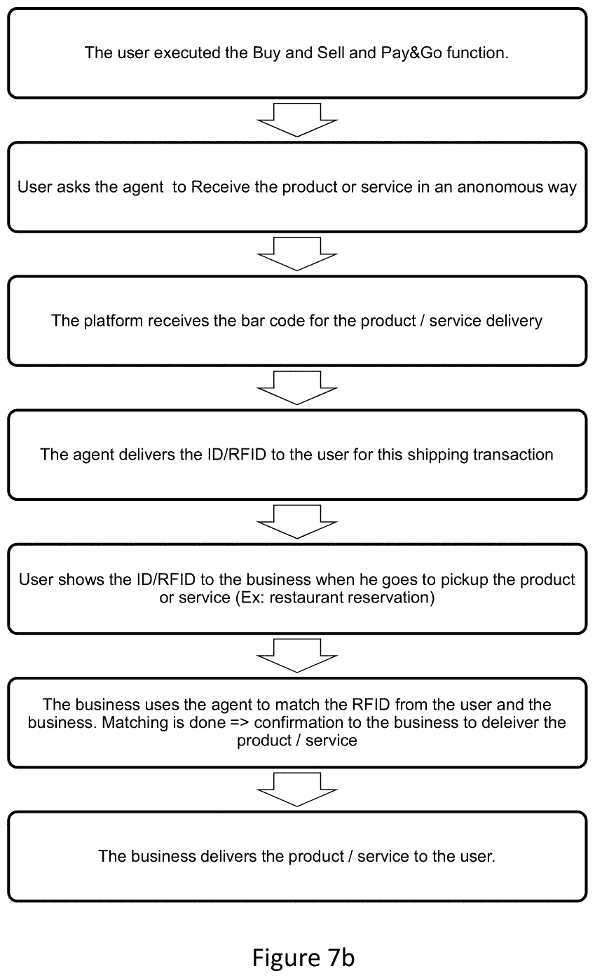

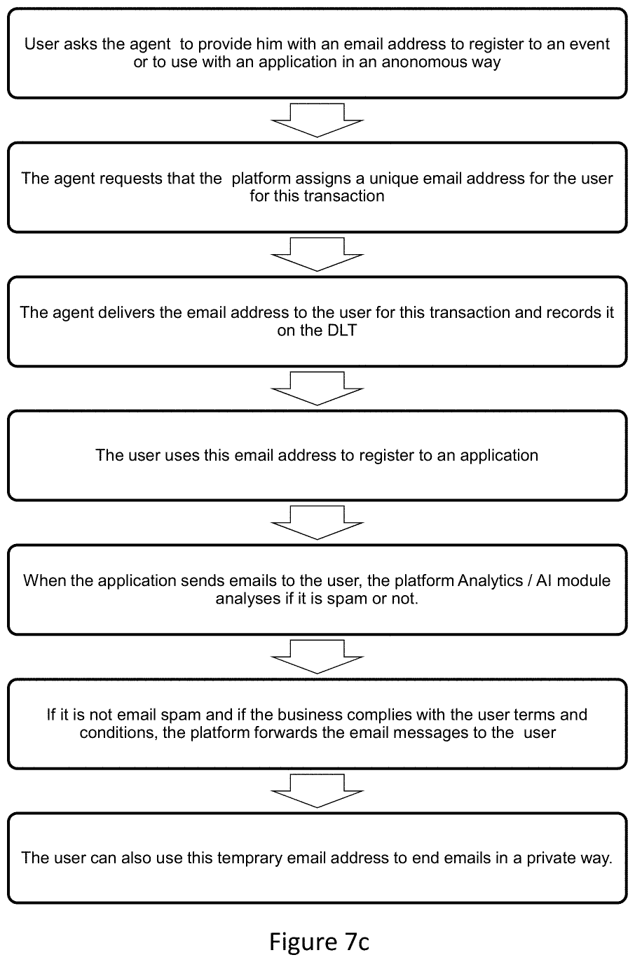

FIG. 7a is a flow diagram of a method for shipping and receiving products and services in a trusted marketplace according to some embodiments of the present technology. The agent requests, from the platform by API, to generate a unique ID for the shipping transaction. The platform uses the ID generator to generate a unique ID for this transaction. The ID is then sent to the user by the agent who will store it in the agent application. In addition, the ID is stored on the DLT for this transaction. This ID is linked to the user and business.

When the user goes to pick up the product or service from the business, the user requests from the agent to receive the product using the interface (UI/UX/API). The agent sends the request to the platform by API. The platform starts a smart contract that validates that the ID exists and that it is matched to the product/service. It then sends the confirmation to the business agent by API. A notification is then shown on the business agent.

After the user receives his product, he confirms receipt to the agent. This confirmation is then sent to the platform that will complete the smart contract and update the status of the ID on the DLT as completed. The DLT is updated.

In some instances, when the platform uses the ID generator to generate a unique ID for this transaction, the ID is then sent to the user and the business by the agent who will store it in the agent application. In addition, the ID is stored on the DLT for this transaction. This ID is linked to the user and business. When the user goes to pick up the product or service from the business, the user requests from the agent to receive the product using the interface (UI/UX/API). The user agent sends the ID to the business agent using a communication protocol between the two devices (such as via Wi-Fi). The business agent validates that it is the same ID as the one he received from the platform and provides a notification message to the business that it has validated the ID by interface (UI/UX/API).

After the user receives his product, he confirms receipt to the agent. This confirmation is then sent to the platform that will complete the smart contract and update the status of the ID on the DLT as completed.

### Ship and Receive in the Online Non-Trusted (Open) Market

FIG. 7b is a flow diagram of a method for shipping and receiving products and services in an open community according to some embodiments of the present technology. The agent requests from the platform, by API, to generate a unique ID for the shipping transaction. The platform uses the ID generator to generate a unique ID for this transaction. The ID is then sent to the user and the business by the agent who will store it in the agent application. In addition, the ID is stored on the DLT for this transaction. This ID is linked to the user and business. This ID can be used to identify the user without exposing his real identity.

When the user goes to pick up the product or service from the business, the user requests from the agent to receive the product using the interface (1.11/UX/API). The user agent sends the ID to the business agent using a communication protocol between the two devices (such as Wi-Fi). The business agent validates that it is the same ID as the one he received from the platform and provides a notification message to the business indicating that the ID has been validated by interface (UI/UX/API).

After the user receives his product, he confirms receipt to the agent. This confirmation is then sent to the platform that will complete the smart contract and update the status of the ID on the DLT as completed.

### Send and Receive Email Anonymously

FIG. 7c is a flow diagram of a method for sending and receiving email according to some embodiments of the present technology. The user nay request, from the agent, by interface (UI/UX/API), to provide him an email address to register to an event or to use with an application in an anonymous way. The agent sends this request by API to the platform who will generate a unique email address for the user for this transaction. The agent delivers the email address to the user. The agent requests that the platform records this transaction on the DLT.

When the user receives an email, the agent sends it to the platform that uses the analytics/API module to validate if the email is a spam. The platform validates also on the DLT the user terms and conditions and whether the business that sends the email complies with the user's terms and conditions. If the email is not spam and if the originator complies with the user's privacy terms and conditions, the platform requests that the agent send the email to the user using his real email address that he provided at registration. If the email is determined to be spam and/or if the business does not comply with the user's terms and conditions, no email is sent to the user.

### Trade Data

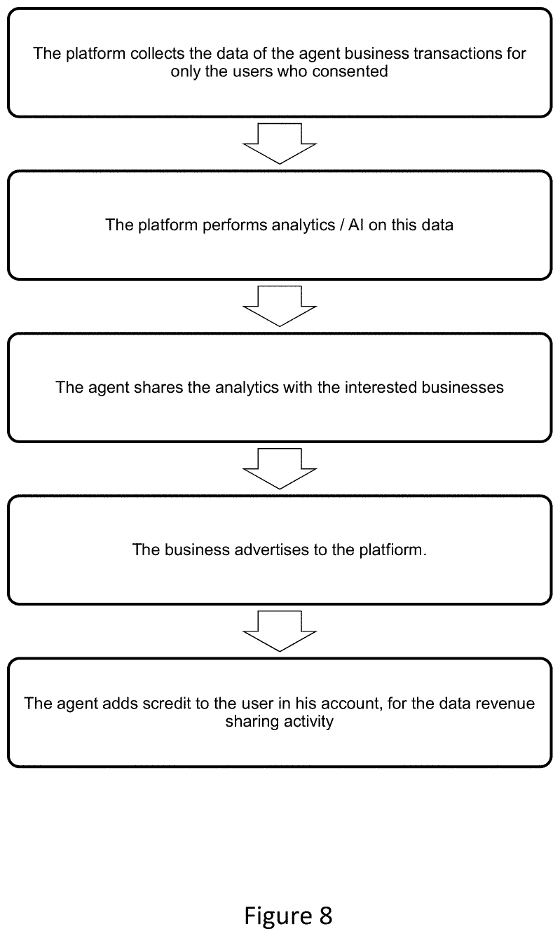

FIG. 8 is a flow diagram of a method for trading data according to some embodiments of the present technology. Data may be collected to serve as data lakes for analytics and business intelligence. When a user business transaction is performed, the agent validates on the DLT if the user consented to have his data used in analytics in an anonymous way, without infringing on his data privacy. If the user consented to perform analytics on his data, the agent requests from the platform to save this data in the data lake (such as a database and/or any other storage structure) in the secure storage. The platform API saves the data (purchase type, amount, etc.) without personal identification.

The platform trade data function initiates an API to perform analytics/AI algorithms on this data lake. Rules are set for analytics/AI to be performed only on the habits of the platform (sum of multiple users) and not on individual users. In addition, the objective is to generate business intelligence about the platform that could be a useful source for businesses and users to help in forecasting and better serving the needs of the community.

### Agent Trading Data and Revenue Sharing

If the business selects the option trading data on the agent interface (UI/UX/API), the agent sends the request to the platform by API that kicks off a smart contract to:
Access the data in the data lake and generate the analytics function.
Other conditions could be also performed by the smart contract, such as validating in the DLT that the business is a trusted business. If not, a request may be sent to the business to sign the legal contract to protect the platform data privacy.
Ensure that transaction payment is made by the business in the trusted community by deducting the transaction amount from the business account and crediting the amount in the platform account or outside the trusted community by initiating the payment API.
Execute the revenue sharing condition, that will calculate the amount per user and for each user, debit the amount from the platform account and credit it in the user account. This will be done for the user whose data is part of the data lake.

The business can view the analytics results on the agent interface UI/UX/API. The platform registers all data transactions and other business transactions history on the DLT.

### View Data Transactions

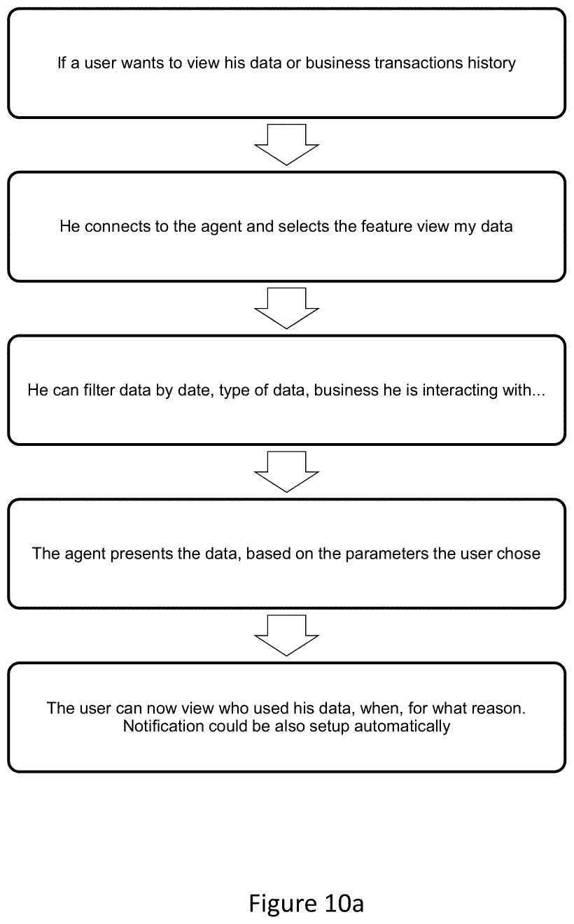

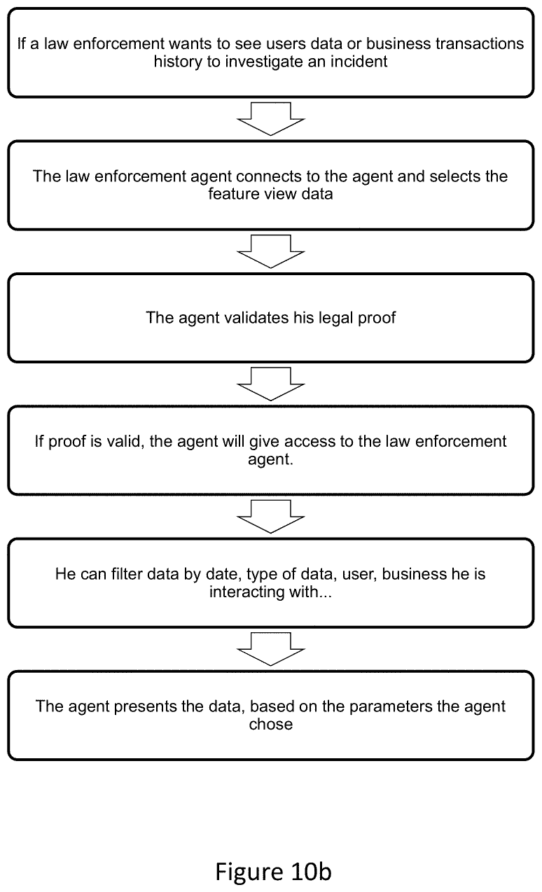

FIG. 10a is a flow diagram of a method for viewing user data according to some embodiments of the present technology. The user may view his own data transaction history. The user selects the view data transaction on the agent UI/UX/API interface. The agent requests the user to authenticate himself. The user may authenticate himself. The user may then select the parameters of the data transactions that he would like to view. These parameters could be the period, date, transactions done by specific business, etc. The agent sends the requests by API to the platform.

A smart contract may be issued to provide the platform the rights to access the user data transactions. The platform connects to the DLT and queries the user's data and provides view access to the user via the agent interface (UI/UX/API). The user can now view all his data transactions based on the parameters that he defined. For example, he can view what accessed his data, when and for what type of transaction. This transaction is added to the history of data transactions on the DLT

FIG. 10b is a flow diagram of a method for viewing user data based on legal proof according to some embodiments of the present technology. In some instances law enforcement agents and/or other entities may view a user's data transaction history with a specific warrant or other legal proof.

The law enforcement agent selects the view data transaction on the agent UI/UX/API interface. The agent requests the user to authenticate himself. The law enforcement agent may then authenticate himself. The agent requests that the law enforcement agent show the warrant and/or other legal proof. The law enforcement agent inputs the warrant. The agent sends a copy of this warrant to the platform. The platform validates and saves this warrant in the secure storage and registers this transaction on the DLT.

The law enforcement agent selects the parameters of the data transactions that he would like to view. These could be the user, period, date, transactions done by specific business, etc. The agent sends the requests by API to the platform. A smart contract is issued to provide the platform the right to access the user data transactions. The platform connects to the DLT and queries the user's data and provides view access to the law enforcement agent via the agent interface (UI/UX/API). The law enforcement agent can now view all the data transactions based on the parameters that he defined. This transaction is added to the history of data transactions on the DLT

### 10—Temporary ID Generator

The platform uses an algorithm to generate a temporary ID per user per business transaction (such as during a pay and go transaction) or per series of transaction (such as buy and sell, pay and go, and ship and receive). The algorithm generates randomly an ID and assigns it only once to the transaction or series of transactions. This temporary ID is kept in the DLT for logging, legal, and/or auditing purposes but is never shared with any businesses. This method will block the businesses from identifying any users after cross-referencing transaction history.

### Computer System

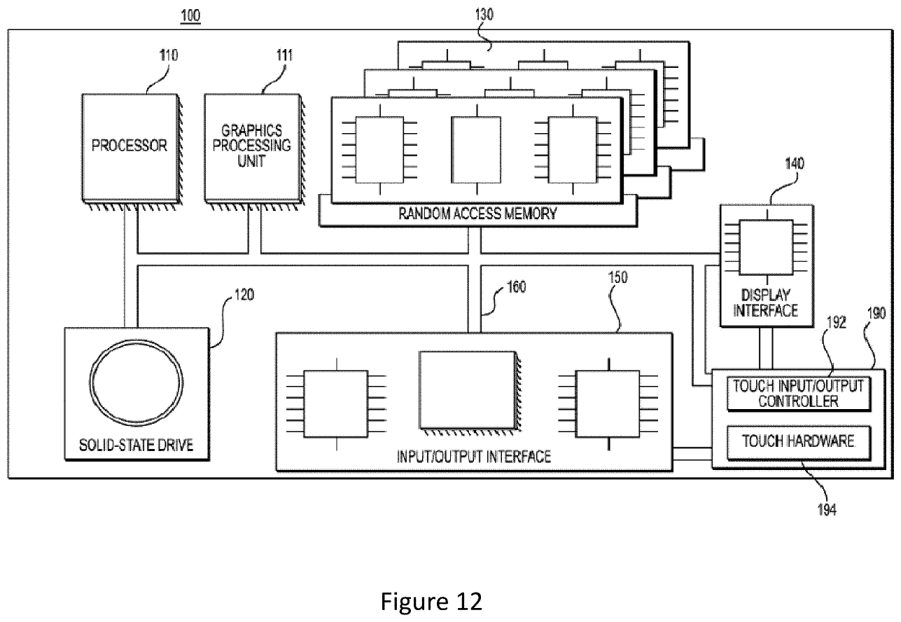

With reference to FIG. 12, there is shown a computer system 100 suitable for use with some implementations of the present technology. In some embodiments, the computer system 100 may be implemented by any of a conventional personal computer, a network device and/or an electronic device (such as, but not limited to, a mobile device, a tablet device, a server, a controller unit, a control device, etc.), and/or any combination thereof appropriate to the relevant task at hand. In some embodiments, the computer system 100 comprises various hardware components including one or more single or multi-core processors collectively represented by processor 110, a solid-state drive 120, a random access memory 130, and an input/output interface 150. The computer system 100 may be a computer specifically designed to operate a machine learning algorithm (MLA). The computer system 100 may be a generic computer system.

In some embodiments, the computer system 100 may also be a subsystem of one of the above-listed systems. The computer system 100 may be an “off-the-shelf” generic computer system. In some embodiments, the computer system 100 may be distributed amongst multiple systems. The computer system 100 may be specifically dedicated to the implementation of the present technology. As a person in the art of the present technology may appreciate, multiple variations as to how the computer system 100 is implemented may be envisioned without departing from the scope of the present technology.

Those skilled in the art will appreciate that processor 110 is generally representative of a processing capability. In some embodiments, in place of or in addition to one or more conventional Central Processing Units (CPUs), one or more specialized processing cores may be provided. For example, one or more Graphic Processing Units 111 (GPUs), Tensor Processing Units (TPUs), and/or other so-called accelerated processors (or processing accelerators) may be provided in addition to or in place of one or more CPUs.

System memory will typically include random access memory 130, but is more generally intended to encompass any type of non-transitory system memory such as static random access memory (SRAM), dynamic random access memory (DRAM), synchronous DRAM (SDRAM), read-only memory (ROM), or a combination thereof. Solid-state drive 120 is shown as an example of a mass storage device, but more generally such mass storage may comprise any type of non-transitory storage device configured to store data, programs, and other information, and to make the data, programs, and other information accessible via a system bus 160. For example, mass storage may comprise one or more of a solid state drive, hard disk drive, a magnetic disk drive, and/or an optical disk drive.

Communication between the various components of the computer system 100 may be enabled by a system bus 160 comprising one or more internal and/or external buses (e.g., a PCI bus, universal serial bus, IEEE 1394 “Firewire” bus, SCSI bus, Serial-ATA bus, ARINC bus, etc.), to which the various hardware components are electronically coupled.

The input/output interface 150 may provide networking capabilities such as wired or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example the networking interface may implement specific physical layer and data link layer standards such as Ethernet, Fibre Channel, Wi-Fi, Cellular Broadband, Token Ring or Serial communication protocols. The specific physical layer and the data link layer may provide a base for a full network protocol stack, allowing communication among small groups of computers on the same local area network (LAN) and large-scale network communications through routable protocols, such as Internet Protocol (IP).

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190.

According to some implementations of the present technology, the solid-state drive 120 stores program instructions suitable for being loaded into the random access memory 130 and executed by the processor 110 for executing acts of one or more methods described herein. For example, at least some of the program instructions may be part of a library or an application.

It should be apparent to those skilled in the art that at least some embodiments of the present technology aim to expand a range of technical solutions for addressing a particular technical problem, namely determining rank positions of elements by a ranking system.

It should be expressly understood that not all technical effects mentioned herein need to be enjoyed in each and every implementation of the present technology. For example, implementations of the present technology may be implemented without the user enjoying some of these technical effects, while other implementations may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A method for performing a transaction between a customer and a business, the method comprising:
receiving a set of terms corresponding to the customer;
receiving, from the customer, an offer corresponding to the transaction;
generating, based on the set of terms and the offer, a smart contract corresponding to the transaction;
generating a user ID corresponding to the customer to be used during the transaction;
transmitting, to the business, the offer and the user ID;
receiving, from the business, a confirmation that the business has accepted the offer;
after the offer has been accepted, executing the smart contract corresponding to the transaction; and
recording, on a digital ledger, a record of the transaction.

2. The method of claim 1, wherein the set of terms corresponding to the customer comprise privacy preferences of the customer.

3. The method of claim 1, wherein the offer comprises an indication of an item or service and a price.

4. The method of claim 1, wherein the user ID is unique to the transaction.

5. The method of claim 1, further comprising transmitting, to the customer, an indication of whether the business is a trusted business.

6. The method of claim 1, further comprising:
selecting a loyalty card number corresponding to the customer;
transmitting the loyalty card number;
generating a smart contract corresponding to the loyalty card number; and
executing the smart contract.

7. The method of claim 6, wherein executing the smart contract causes loyalty points to be deducted from an account corresponding to the business and added to an account corresponding to the loyalty card number.

8. The method of claim 1, further comprising sending a token indicating that the transaction has been completed to the customer.

9. The method of claim 1, further comprising sending a token indicating that the transaction has been completed to the business.

10. A method for fulfilling a transaction between a customer and a business, the method comprising:
receiving an indication that the customer purchased a product or service;
generating a user ID corresponding to the customer to be used for fulfilling the transaction;
storing, on a distributed ledger, the user ID;
receiving, via a user interface, a request from the customer to receive the product or the service;
validating, by a smart contract, that the user ID corresponds to the transaction;
sending, to the business, a notification that the transaction has been validated;
receiving, from the customer, a confirmation that the transaction has been completed;
after receiving the confirmation, completing a smart contract corresponding to the transaction; and
storing, on the distributed ledger, an indication that the transaction has been fulfilled.

11. The method of claim 10, wherein receiving the indication that the customer purchased the product or the service comprises receiving, via the distributed ledger, the indication.

12. The method of claim 10, wherein receiving the request from the customer to receive the product or the service comprises receiving an indication that the customer is in a physical location corresponding to the business.

13. The method of claim 12, wherein sending the notification that the transaction has been validated comprises sending an indication of the user ID to the business.

14. The method of claim 10, further comprising sending a token indicating that the transaction has been completed to the business.

15. A method for providing advertising to users, the method comprising:
receiving, from a business, a request to advertise an offer;
receiving a set of privacy conditions corresponding to the business;
generating, based on the offer and the set of privacy conditions, smart contracts corresponding to the offer;
storing the smart contracts on a distributed ledger;
generating, based on the offer and a template, an advertisement;
executing the smart contracts to determine a set of users to provide the advertisement to;
determining, based on preferences corresponding to each user of the set of users, a method of delivering the advertisement to the respective user;
receiving indications of user interactions with the advertisement;
storing the indications of user interactions on the distributed ledger;
generating, based on the smart contracts and based on the indications of user interactions, advertising results; and
sending the advertising results to the business.

16. The method of claim 15, wherein the request comprises an indication of a product or service, a price, and terms of the offer.

17. The method of claim 15, wherein executing the smart contracts comprises identifying users with privacy settings that are compatible with the set of privacy conditions.

18. The method of claim 15, wherein executing the smart contracts comprises identifying users with interests corresponding to the offer.

19. The method of claim 15, wherein sending the advertising results to the business comprises sending anonymized data to the business.

20. The method of claim 15, wherein the advertising results comprise an amount of users that interacted with the advertisement.
